(19) United States
(12) Patent Application Publication
(10) Pub. No.: US 2013/0246233 A1
(43) Pub. Date: Sep. 19, 2013

(54) Method for Virtual Currency Futures Transactions

(71) Applicant: GOLD INNOVATIONS, LLC, Austin, TX (US)

(72) Inventor: Omar Besim Hakim, Austin, TX (US)

(73) Assignee: Gold Innovations, LLC, Austin, TX (US)

(21) Appl. No.: 13/892,973

(22) Filed: May 13, 2013

Related U.S. Application Data
(63) Continuation-in-part of application No. 13/282,197, filed on Oct. 26, 2011, now Pat. No. 8,447,675.
(60) Provisional application No. 61/406,587, filed on Oct. 26, 2010.

(51) Int. Cl. G06Q 30/02

(52) U.S. Cl. CPC G06Q 30/0283
USPC 705/30

(57) ABSTRACT

A legal tender value of an accounting system entry is recorded. A currency alternative unit decomposition of the accounting system entry is recorded. The accounting system entry represents at least one or more currency alternative units associated with a financial transaction.

### CLAIM OF PRIORITY TO PROVISIONAL APPLICATION

This application is a continuation-in-part of U.S. patent application Ser. No. 13/282,197 entitled “METHODS AND APPARATUS FOR RECORDING LEGAL TENDER DECOMPOSITION OF ACCOUNTING SYSTEM ENTRIES” filed Oct. 26, 2011, which claims benefit of priority of U.S. Provisional Application Ser. No. 61/406,587 entitled “METHOD AND SYSTEM FOR DETERMINING, CALCULATING AND MANAGING THE TAXES OWED ON THE SALE OF LEGAL TENDER COINS WHICH HAVE A MATERIAL VALUE GREATER THAN THEIR LEGAL FACE VALUE” filed Oct. 26, 2010.

### BACKGROUND

### Description of the Related Art

Various market participants have provided accounting software to support financial activity. Accounting software is application software that records and processes accounting transactions within functional modules such as accounts payable, accounts receivable, payroll, and trial balance. Accounting software functions as an accounting information system. Accounting software may be developed in-house by the company or organization using the accounting software, may be purchased or licensed from a third party, or may be a combination of a third-party application software package with local modifications. Accounting software varies greatly in its complexity and cost.

Today, accounting software does not enable the recording of the decomposition of an accounting system entry (e.g., particular values or identities of bank notes, types of coins, or checks) within a particular currency. Currency refers to a generally accepted medium of exchange, which are most commonly the coins and banknotes of a particular government or region. Usually, a government legally defines its fiat currency (typically notes and coins issued by the central bank) to be legal tender, fixing a legal tender value that is independent of its material or composition value. Government decree, rather than material value, determines the value of money for accounting purposes.

As a result, bank deposits and currency transactions are generally tracked by an accounting system without regard to the legal tender composition of the transactions. For example, under Generally Accepted Accounting Principles in the United States (US GAAP), economic activity is measured in U.S. dollars, and transactions are expressed in U.S. dollars when recorded, without US GAAP requiring there to be a recorded difference between various forms of legal tender for the same legal tender value in an accounting system entry. See FASB Statement No. 168, The FASB Accounting Standards Codification™ and the Hierarchy of Generally Accepted Accounting Principles. For example, a $100 accounting system entry is not shown to be made up of two $50 bills or five $20 bills, etc.

More recently, the rise of virtual currencies has created nightmares of currency instability. Digital currency, among its various names, is electronic money that acts as alternative currency. Currently, alternative digital currencies are not produced by government-endorsed central banks nor necessarily backed by national currency. Digital currency, such as Bitcoin™, are examples of currency alternative units. Bitcoin is not the only digital currency, nor the only successful one. Gamers on Second Life™, a virtual world, pay with Linden Dollars™; customers of Tencent™, a Chinese internet giant, deal in QQ Coins™; and Facebook™ sells “Credits”. What makes Bitcoin™ different is that, unlike other online (and offline) currencies, it is neither created nor administered by a single authority such as a central bank, creating disorder.

Instead, new Bitcoins™ have to be “mined”, meaning users can acquire them by having their computers compete to solve complex mathematical problems (the winners get the virtual cash). The coins themselves are simply strings of numbers. They are thus a completely decentralised currency: a sort of digital gold. Businesses have started to accept Bitcoins™. Among them are Reddit™, a social-media site, and WordPress™, which provides web hosting and software for bloggers. The appeal for merchants is strong. Firms such as BitPay™ offer spot-price conversion into dollars, and spot prices fluctuate wildly. Fees are typically far less than those charged by credit-card companies or banks, particularly for orders from abroad. And Bitcoin™ transactions cannot be reversed, so frauds cannot leave retailers out of pocket.

### SUMMARY

Various embodiments of methods and apparatus for recording decomposition of accounting system entries are disclosed. In some embodiments, one or more processors are employed to perform recording a legal tender value of an accounting system entry and recording a legal tender decomposition of the accounting system entry.

In some embodiments, the one or more processors are employed to perform reporting the legal tender decomposition of the accounting system entry and the legal tender value of the accounting system entry.

In some embodiments, the one or more processors are employed to perform recording a legal tender value of an accounting system entry, and recording a currency alternative unit decomposition of the accounting system entry. In some embodiments, the accounting system entry represents at least one or more currency alternative units associated with a financial transaction. In some embodiments, the one or more processors are employed to perform calculating a financial amount for the financial transaction utilizing at least the currency alternative unit decomposition of the accounting system entry. The one or more processors are employed to perform facilitating the financial transaction. In some embodiments, the calculating a financial amount for the financial transaction utilizing at least the currency alternative unit decomposition of the accounting system entry further includes calculating a financial amount for the financial transaction utilizing at least the currency alternative unit decomposition representing an amount of virtual currency units.

In some embodiments, the facilitating the financial transaction further includes calculating an expected future value of the currency alternative unit decomposition and providing access to funds representing the expected future value via a debit card. In some embodiments, the calculating a financial amount for the financial transaction utilizing at least the currency alternative unit decomposition of the accounting system entry further includes calculating a financial amount for the financial transaction utilizing at least the currency alternative unit decomposition representing an amount of legal tender bullion coins. In some embodiments, the one or more processors are employed to perform preparing a report of the financial transaction. The preparing the report further includes reporting the currency alternative unit decomposition and recording the financial transaction in a storage medium. In some embodiments, the one or more processors are employed to perform reporting the currency alternative unit decomposition of the accounting system entry and the legal tender value of the accounting system entry. In some embodiments, the one or more processors are employed to perform calculating a composition value of the accounting system entry based at least in part on the currency alternative unit decomposition of the accounting system entry. The composition value is based at least in part on an algorithmic prediction of future supply or demand associated with the currency alternative unit.

Some embodiments include a system with at least one processor and a memory storing program instructions. The program instructions are executable by the at least one processor to record a legal tender value of an accounting system entry, and record a currency alternative unit decomposition of the accounting system entry. The accounting system entry represents at least one or more currency alternative units associated with a financial transaction. In some embodiments, the system further includes program instructions executable by the at least one processor to calculate a financial amount for the financial transaction utilizing at least the currency alternative unit decomposition of the accounting system entry. In some embodiments, the system further includes program instructions executable by the at least one processor to facilitate the financial transaction. In some embodiments, the program instructions executable by the at least one processor to calculate a financial amount for the financial transaction utilizing at least the currency alternative unit decomposition of the accounting system entry further include program instructions executable by the at least one processor to calculate a financial amount for the financial transaction utilizing at least the currency alternative unit decomposition representing an amount of virtual currency units.

In some embodiments, the program instructions executable by the at least one processor to facilitate the financial transaction further include program instructions executable by the at least one processor to calculate an expected future value of the currency alternative unit decomposition, and program instructions executable by the at least one processor to provide access to funds representing the expected future value via a debit card. In some embodiments, the program instructions executable by the at least one processor to calculate a financial amount for the financial transaction utilizing at least the currency alternative unit decomposition of the accounting system entry further include program instructions executable by the at least one processor to calculate a financial amount for the financial transaction utilizing at least the currency alternative unit decomposition representing an amount of legal tender bullion coins.

In some embodiments, the system further includes program instructions executable by the at least one processor to prepare a report of the financial transaction. The program instructions executable by the at least one processor to prepare the report further include program instructions executable by the at least one processor to report the currency alternative unit decomposition. In some embodiments, the system further includes program instructions executable by the at least one processor to record the financial transaction in a storage medium. In some embodiments, the system further includes program instructions executable by the at least one processor to report the currency alternative unit decomposition of the accounting system entry and the legal tender value of the accounting system entry.

In some embodiments, the system further includes program instructions executable by the at least one processor to calculate a composition value of the accounting system entry based at least in part on the currency alternative unit decomposition of the accounting system entry. The composition value is based at least in part on an algorithmic prediction of future supply or demand associated with the currency alternative unit.

Some embodiments provide a non-transitory computer-readable storage medium storing program instructions. The program instructions are computer-executable to implement recording a legal tender value of an accounting system entry, and recording a currency alternative unit decomposition of the accounting system entry. In some embodiments, the accounting system entry represents at least one or more currency alternative units associated with a financial transaction. In some embodiments, the non-transitory computer-readable storage medium stores program instructions computer-executable to implement calculating a financial amount for the financial transaction utilizing at least the currency alternative unit decomposition of the accounting system entry.

In some embodiments, the non-transitory computer-readable storage medium stores program instructions computer-executable to implement facilitating the financial transaction. In some embodiments, the program instructions computer-executable to implement calculating a financial amount for the financial transaction utilizing at least the currency alternative unit decomposition of the accounting system entry further include program instructions computer-executable to implement calculating a financial amount for the financial transaction utilizing at least the currency alternative unit decomposition representing an amount of virtual currency units. In some embodiments, the program instructions computer-executable to implement facilitating the financial transaction further include program instructions computer-executable to implement calculating an expected future value of the currency alternative unit decomposition, and program instructions computer-executable to implement providing access to funds representing the expected future value via a debit card.

In some embodiments, the program instructions computer-executable to implement calculating a financial amount for the financial transaction utilizing at least the currency alternative unit decomposition of the accounting system entry further include program instructions computer-executable to implement calculating a financial amount for the financial transaction utilizing at least the currency alternative unit decomposition representing an amount of legal tender bullion coins. In some embodiments, the non-transitory computer-readable storage medium stores program instructions computer-executable to implement preparing a report of the financial transaction. The program instructions computer-executable to implement preparing the report further include program instructions computer-executable to implement reporting the currency alternative unit decomposition. In some embodiments, the non-transitory computer-readable storage medium stores program instructions computer-executable to implement recording the financial transaction in a storage medium. In some embodiments, the non-transitory computer-readable storage medium stores program instructions computer-executable to implement reporting the currency alternative unit decomposition of the accounting system entry and the legal tender value of the accounting system entry. In some embodiments, the non-transitory computer-readable storage medium stores program instructions computer-executable to implement calculating a composition value of the accounting system entry based at least in part on the currency alternative unit decomposition of the accounting system entry. The composition value is based at least in part on an algorithmic prediction of future supply or demand associated with the currency alternative unit.

In some embodiments, the one or more processors are employed to perform calculating a composition value of the accounting system entry based at least in part on the legal tender decomposition of the accounting system entry.

In some embodiments, the one or more processors are employed to perform calculating a composition value of the accounting system entry based at least in part on the legal tender decomposition of the accounting system entry. In some such embodiments, the calculating the composition value is based at least in part on a material value of coins included in the legal tender decomposition.

In some embodiments, the one or more processors are employed to perform calculating a composition value of the accounting system entry based at least in part on the legal tender decomposition of the accounting system entry. In some such embodiments, the one or more processors are further employed to perform calculating a comparison of the legal tender value of the accounting system entry and the composition value of the accounting system entry. In some such embodiments, the one or more processors are further employed to perform reporting the legal tender value of accounting system entry, the composition value of the accounting system entry, and the comparison of the legal tender value of accounting system entry and the composition value of the accounting system entry.

In some embodiments, the one or more processors are employed to perform calculating a transaction value based at least in part on the comparison of the legal tender value of accounting system entry and the composition value of the accounting system entry.

In some embodiments, the one or more processors are employed to perform calculating a dual-treatment aggregate value based in part on the legal the legal tender decomposition of the accounting system entry and the legal tender value of the accounting system entry.

In some embodiments, the one or more processors are employed to perform calculating a first composition value of the accounting system entry based at least in part on the legal tender decomposition of the accounting system entry. In some such embodiments, the calculating the first composition value is based at least in part on a metal composition of coins included in the legal tender decomposition and a metal price on a first date. In some such embodiments, the one or more processors are further employed to perform calculating a second composition value of the accounting system entry based at least in part on the legal tender decomposition of the accounting system entry. In some such embodiments, the calculating the second composition value is based at least in part on a metal composition of coins included in the legal tender decomposition and a metal price on a second date. In some such embodiments, the one or more processors are further employed to perform calculating a comparison of the first composition value and the second composition value. In some such embodiments, the one or more processors are further employed to perform reporting the legal tender value of accounting system entry, the first composition value, the second composition value, and the comparison.

Some embodiments provide a system including at least one processor and a memory comprising program instructions. In some embodiments, the program instructions are executable by the at least one processor to record a legal tender value of an accounting system entry and record a legal tender decomposition of the accounting system entry.

In some embodiments, the program instructions are further executable by the at least one processor to report the legal tender decomposition of the accounting system entry and the legal tender value of the accounting system entry.

In some embodiments, the program instructions are further executable by the at least one processor to calculate a composition value of the accounting system entry based at least in part on the legal tender decomposition of the accounting system entry.

In some embodiments, the program instructions are further executable by the at least one processor to calculate a composition value of the accounting system entry based at least in part on the legal tender decomposition of the accounting system entry, and the composition value is based at least in part on a material value of coins included in the legal tender decomposition.

In some embodiments, the program instructions are further executable by the at least one processor to calculate a dual-treatment aggregate value based in part on the legal the legal tender decomposition of the accounting system entry and the legal tender value of the accounting system entry.

In some embodiments, the program instructions are further executable by the at least one processor to calculate a composition value of the accounting system entry based at least in part on the legal tender decomposition of the accounting system entry. In some such embodiments, the program instructions are further executable by the at least one processor to calculate a comparison of the legal tender value of the accounting system entry and the composition value of the accounting system entry and report the legal tender value of accounting system entry, the composition value of the accounting system entry, and the comparison of the legal tender value of accounting system entry and the composition value of the accounting system entry.

In some embodiments, the program instructions are further executable by the at least one processor to calculate a transaction value based at least in part on the comparison of the legal tender value of accounting system entry and the composition value of the accounting system entry.

In some embodiments, the program instructions are further executable by the at least one processor to calculate a first composition value of the accounting system entry based at least in part on the legal tender decomposition of the accounting system entry. In some such embodiments, the first composition value is based at least in part on a metal composition of coins included in the legal tender decomposition and a metal price on a first date. In some embodiments, the program instructions are further executable by the at least one processor to calculate a second composition value of the accounting system entry based at least in part on the legal tender decomposition of the accounting system entry. In some such embodiments, the second composition value is based at least in part on a metal composition of coins included in the legal tender decomposition and a metal price on a second date. In some embodiments, the program instructions are further executable by the at least one processor to calculate a comparison of the first composition value and the second composition value and report the legal tender value of accounting system entry, the first composition value, the second composition value, and the comparison.

Some embodiments provide a non-transitory computer-readable storage medium storing program instructions. In some embodiments, the program instructions are computer-executable to implement recording a legal tender value of an accounting system entry and recording a legal tender decomposition of the accounting system entry.

In some embodiments the program instructions are further computer-executable to implement reporting the legal tender decomposition of the accounting system entry and the legal tender value of the decomposition.

In some embodiments the program instructions are further computer-executable to implement calculating a composition value of the accounting system entry based at least in part on the legal tender decomposition of the accounting system entry.

In some embodiments the program instructions are further computer-executable to implement calculating a composition value of the accounting system entry based at least in part on the legal tender decomposition of the accounting system entry. In some such embodiments, the composition value is based at least in part on a material value of coins included in the legal tender decomposition.

In some embodiments the program instructions are further computer-executable to implement calculating a composition value of the accounting system entry based at least in part on the legal tender decomposition of the accounting system entry.

In some such embodiments, the program instructions are further computer-executable to implement calculating a comparison of the legal tender value of the accounting system entry and the composition value of the accounting system entry. In some such embodiments, the program instructions are further computer-executable to implement reporting the legal tender value of accounting system entry, the composition value of the accounting system entry, and the comparison of the legal tender value of accounting system entry and the composition value of the accounting system entry.

In some embodiments the program instructions are further computer-executable to implement calculating a transaction value based at least in part on the comparison of the legal tender value of accounting system entry and the composition value of the accounting system entry.

In some embodiments, one or more processors are employed to perform recording a legal tender value of an accounting system entry, recording a legal tender decomposition of the accounting system entry and preparing a proposed transaction report for a financial services transaction, wherein terms of a proposed transaction described in the proposed transaction report depend at least in part on the legal tender value and the legal tender decomposition.

In some embodiments, the preparing a proposed transaction report for a financial services transaction further includes calculating a composition value based in part on the legal tender decomposition, calculating a dual-treatment aggregate value based in part on the composition value, and based on the dual-treatment aggregate value, designating terms of the financial services transaction for use in the proposed transaction report.

In some embodiments, the preparing a proposed transaction report for a financial services transaction further includes calculating a composition value based in part on the legal tender decomposition, calculating a dual-treatment aggregate value based in part on the composition value, and based on the dual-treatment aggregate value, designating terms of the financial services transaction for use in the proposed transaction report. In some such embodiments, the terms of the financial services transaction include a loan secured by one or more coins represented by the legal tender decomposition of the accounting system entry.

In some embodiments, the preparing a proposed transaction report for a financial services transaction further includes calculating a composition value based in part on the legal tender decomposition, calculating a dual-treatment aggregate value based in part on the composition value, and based on the dual-treatment aggregate value, designating terms of the financial services transaction for use in the proposed transaction report. In some such embodiments, the terms of the financial services transaction include a proposed sale of one or more coins represented by the legal tender decomposition of the accounting system entry.

In some embodiments, the preparing a proposed transaction report for a financial services transaction further includes calculating a composition value based in part on the legal tender decomposition, calculating a dual-treatment aggregate value based in part on the composition value, and based on the dual-treatment aggregate value, designating terms of the financial services transaction for use in the proposed transaction report. In some such embodiments, the terms of the financial services transaction include a futures contract based at least in part on the legal tender decomposition of the accounting system entry.

In some embodiments, the preparing a proposed transaction report for a financial services transaction further includes calculating a composition value based in part on the legal tender decomposition, calculating a dual-treatment aggregate value based in part on the composition value, and based on the dual-treatment aggregate value, designating terms of the financial services transaction for use in the proposed transaction report. In some such embodiments, the terms of the financial services transaction include an option contract based at least in part on the legal tender decomposition of the accounting system entry.

In some embodiments, the preparing a proposed transaction report for a financial services transaction further includes calculating a composition value based in part on the legal tender decomposition, calculating a dual-treatment aggregate value based in part on the composition value, and based on the dual-treatment aggregate value, designating terms of the financial services transaction for use in the proposed transaction report. In some such embodiments, the terms of the financial services transaction include tax payments based at least in part on the legal tender decomposition of the accounting system entry.

In some embodiments, the preparing a proposed transaction report for a financial services transaction further includes calculating a composition value based in part on the legal tender decomposition, calculating a dual-treatment aggregate value based in part on the composition value, and based on the dual-treatment aggregate value, designating terms of the financial services transaction for use in the proposed transaction report. In some such embodiments, the terms of the financial services transaction include a series of advance payments based at least in part on the legal tender decomposition of the accounting system entry.

In some embodiments, the preparing a proposed transaction report for a financial services transaction further includes calculating a composition value based in part on the legal tender decomposition, calculating a dual-treatment aggregate value based in part on the composition value, and based on the dual-treatment aggregate value, designating terms of the financial services transaction for use in the proposed transaction report. In some such embodiments, the terms of the financial services transaction include payment terms modeled on predicted fluctuations of the composition value in response to changes in a spot price of one or more precious metals.

In some embodiments, the preparing a proposed transaction report for a financial services transaction further includes based on the dual-treatment aggregate value, designating terms of the financial services transaction for use in the proposed transaction report, wherein the terms of the financial services transaction include a loan secured by collateral comprising one or more coins represented by the legal tender decomposition of the accounting system entry, wherein terms of the loan are based at least in part on one or more futures contracts for determining the composition value of the accounting system entry.

In some embodiments, the preparing a proposed transaction report for a financial services transaction further includes based on the dual-treatment aggregate value, designating terms of the financial services transaction for use in the proposed transaction report, wherein the terms of the financial services transaction include a loan secured by collateral comprising one or more coins represented by the legal tender decomposition of the accounting system entry, wherein terms of the loan are based at least in part on one or more futures contracts for determining the composition value of the accounting system entry.

In some embodiments, one or more processors are employed to perform defining collateral for a financial transaction, assessing a valuation of the collateral based upon a difference between a material value and a legal tender value of the legal tender precious metal coins, and determining terms of the financial transaction based on the valuation. In some embodiments the collateral includes one or more legal tender precious metal coins. In some embodiments, the one or more processors are employed to perform executing payments based on the terms of the financial transaction.

In some embodiments, the determining the terms of the financial transaction further includes determining terms of a loan based upon the valuation. In some embodiments, the determining the terms of the financial transaction further includes determining terms of the financial transaction based on a dual treatment aggregate value of the collateral. In some embodiments, the determining the terms of the financial transaction further includes determining valuations of one or more futures contracts. In some embodiments, the determining the terms of the financial transaction further includes determining valuation of a present payment for an agreed future transfer of the collateral based on an agreed future value of the collateral. In some embodiments, the determining the terms of the financial transaction further includes determining terms of a line of credit based upon the valuation. In some embodiments, the determining the terms of the financial transaction further includes determining terms of a payment annuity based upon the valuation. In some embodiments, the determining the terms of the financial transaction further includes determining terms of an insurance contract based upon the valuation. In some embodiments, the determining the terms of the financial transaction further includes determining terms of a purchase transaction based upon the valuation.

Some embodiments provide a system including at least one processor and a memory comprising program instructions. In some embodiments, the program instructions are executable by the at least one processor to define collateral for a financial transaction, assess a valuation of the collateral based upon a difference between a material value and a legal tender value of the legal tender precious metal coins, and determine terms of the financial transaction based on the valuation. In some embodiments, the collateral includes one or more legal tender precious metal coins. In some embodiments, the program instructions are further executable by the at least one processor to execute payments based on the terms of the financial transaction.

In some embodiments, the program instructions executable by the at least one processor to determine the terms of the financial transaction further include program instructions executable by the at least one processor to determine terms of a loan based upon the valuation. In some embodiments, the program instructions executable by the at least one processor to determine the terms of the financial transaction further include program instructions executable by the at least one processor to determine terms of the financial transaction based on a dual treatment aggregate value of the collateral. In some embodiments, the program instructions executable by the at least one processor to determine the terms of the financial transaction further include program instructions executable by the at least one processor to determine valuations of one or more futures contracts. In some embodiments, the program instructions executable by the at least one processor to determine the terms of the financial transaction further include program instructions executable by the at least one processor to determine valuation of a present payment for an agreed future transfer of the collateral based on an agreed future value of the collateral.

In some embodiments, the program instructions executable by the at least one processor to determine the terms of the financial transaction further include program instructions executable by the at least one processor to determine terms of a line of credit based upon the valuation. In some embodiments, the program instructions executable by the at least one processor to determine the terms of the financial transaction further include program instructions executable by the at least one processor to determine terms of a payment annuity based upon the valuation. In some embodiments, the program instructions executable by the at least one processor to determine the terms of the financial transaction further include program instructions executable by the at least one processor to determine terms of an insurance contract based upon the valuation. In some embodiments, the program instructions executable by the at least one processor to determine the terms of the financial transaction further include program instructions executable by the at least one processor to determine terms of a purchase transaction based upon the valuation.

Some embodiments provide a non-transitory computer-readable storage medium storing program instructions. In some embodiments, the program instructions are computer-executable to implement defining collateral for a financial transaction, wherein the collateral includes one or more legal tender precious metal coins, assessing a valuation of the collateral based upon a difference between a material value and a legal tender value of the legal tender precious metal coins, and determining terms of the financial transaction based on the valuation. In some embodiments, the program instructions are computer-executable to implement executing payments based on the terms of the financial transaction.

In some embodiments, the program instructions computer-executable to implement determining the terms of the financial transaction further include program instructions computer-executable to implement determining terms of a loan based upon the valuation. In some embodiments, the program instructions computer-executable to implement determining the terms of the financial transaction further include program instructions computer-executable to implement determining terms of the financial transaction based on a dual treatment aggregate value of the collateral. In some embodiments, the program instructions computer-executable to implement determining the terms of the financial transaction further include program instructions computer-executable to implement determining valuations of one or more futures contracts. In some embodiments, the program instructions computer-executable to implement determining the terms of the financial transaction further include program instructions computer-executable to implement determining valuation of a present payment for an agreed future transfer of the collateral based on an agreed future value of the collateral.

In some embodiments, the program instructions computer-executable to implement determining the terms of the financial transaction further include program instructions computer-executable to implement determining terms of a line of credit based upon the valuation. In some embodiments, the program instructions computer-executable to implement determining the terms of the financial transaction further include program instructions computer-executable to implement determining terms of a payment annuity based upon the valuation. In some embodiments, the program instructions computer-executable to implement determining the terms of the financial transaction further include program instructions computer-executable to implement determining terms of an insurance contract based upon the valuation. In some embodiments, the program instructions computer-executable to implement determining the terms of the financial transaction further include program instructions computer-executable to implement determining terms of a purchase transaction based upon the valuation.

### BRIEF DESCRIPTION OF THE DRAWINGS

FIG. 1A illustrates a system architecture for recording decomposition of accounting system entries, according to some embodiments.

FIG. 1B illustrates a system architecture for recording decomposition of accounting system entries, according to some embodiments.

FIG. 2A depicts a module that that may be used for recording decomposition of accounting system entries, according to some embodiments.

FIG. 2B depicts a module that that may be used for recording decomposition of accounting system entries, according to some embodiments.

FIGS. 3A-3C illustrate a series of decompositions of accounting system entries that may be recorded, according to some embodiments.

FIG. 4 is a high-level logical flowchart of operations usable for recording decomposition of accounting system entries, according to some embodiments.

FIG. 5 is a high-level logical flowchart of operations that can be used for recording and reporting decomposition of accounting system entries, according to some embodiments.

FIG. 6 is a high-level logical flowchart of operations that can be used for a law enforcement application of recording decomposition of accounting system entries, according to some embodiments.

FIG. 7 is a high-level logical flowchart of operations that can be used for a fully mechanized recording of decomposition of accounting system entries, according to some embodiments.

FIG. 8 is a high-level logical flowchart of operations that can be used for a recording of decomposition of accounting system entries with composition value computation, according to some embodiments.

FIG. 9A is a high-level logical flowchart of operations that can be used for recording decomposition of accounting system entries with tax reporting, according to some embodiments.

FIG. 9B is a high-level logical flowchart of operations that can be used for recording decomposition of accounting system entries with accounting computation for variable composition value, according to some embodiments.

FIG. 9C is a high-level logical flowchart of operations that can be used for managing collateral-based financial transactions, according to some embodiments.

FIG. 9D is a high-level logical flowchart of operations that can be used for managing collateral-based financial transactions, according to some embodiments.

FIG. 10A is a time-value diagram of a transaction using recording of decomposition of accounting system entries with tax reporting, according to some embodiments.

FIG. 10B is a decomposition-value diagram of a transaction using recording of decomposition of accounting system entries with tax reporting, according to some embodiments.

FIG. 10C is a flow of finance diagram describing a transaction using recording of decomposition of accounting system entries with tax reporting, according to some embodiments.

FIG. 10D is a flow of finance diagram describing a transaction using recording of decomposition of accounting system entries with tax reporting, according to some embodiments.

FIG. 11 depicts one embodiment of a graphical user interface for recording decomposition of accounting system entries.

FIG. 12A is a high-level logical flowchart of operations that can be used for supporting financial services transactions based at least in part on decomposition of accounting system entries, according to some embodiments.

FIG. 12B is a high-level logical flowchart of operations that can be used for preparing proposed transaction reports in support of financial services transactions based at least in part on decomposition of accounting system entries, according to some embodiments.

FIG. 13 is a high-level logical flowchart of operations that can be used for operations on accounting system entries that may be recorded for currency alternative units, according to some embodiments.

FIG. 14 is a high-level logical flowchart of operations that can be used for operations on accounting system entries that may be recorded for currency alternative units, according to some embodiments.

FIG. 15 is a high-level logical flowchart of operations that can be used for operations on accounting system entries that may be recorded for currency alternative units, according to some embodiments.

FIG. 16 is a high-level logical flowchart of operations that can be used for operations on accounting system entries that may be recorded for currency alternative units, according to some embodiments.

FIG. 17 is a high-level logical flowchart of operations that can be used for operations on accounting system entries that may be recorded for currency alternative units, according to some embodiments.

FIG. 18 is a high-level logical flowchart of operations that can be used for operations on accounting system entries that may be recorded for currency alternative units, according to some embodiments.

FIG. 19 is a high-level logical flowchart of operations that can be used for operations on accounting system entries that may be recorded for currency alternative units, according to some embodiments.

FIG. 20A is a high-level logical flowchart of operations that can be used for operations on accounting system entries that may be recorded for currency alternative units, according to some embodiments.

FIG. 20B is a high-level logical flowchart of operations that can be used for operations on accounting system entries that may be recorded for currency alternative units, according to some embodiments.

FIG. 20C is a flow of finance diagram describing a transaction using recording of decomposition of accounting system entries with tax reporting, according to some embodiments.

FIG. 21 illustrates an example computer system that may be used in embodiments.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Various embodiments of methods and apparatus for recording decomposition of accounting system entries are disclosed. In one embodiment, one or more processors are employed to perform recording a legal tender value of an accounting system entry in a currency and recording a currency alternative unit decomposition of the accounting system entry in the currency.

As used herein, “currency alternative unit decomposition” refers to an array of data values (elements) representing identities of units of virtual currency and/or deposit entries representing units of virtual currency of which a payment of an accounting system entry is, will be, was, or theoretically is composed. In some embodiments, currency alternative unit decomposition elements (e.g., made up of bitcoins and/or other virtual currency) of a legal tender decomposition sum to a total value of an accounting system entry in a virtual currency system. In some embodiments, a currency alternative unit decomposition comprises an identification of a unit of virtual currency, a date and/or time of a transaction, and a value of the virtual currency in an alternative currency or a currency alternative, including but not limited to federal reserve notes, other national currency notes, precious metal bullion units, legal tender bullion coins, other virtual currencies, a currency of a foreign jurisdiction, or units of a commercial commodity.

As used herein, “currency alternative units” refer to units of virtual currency and/or deposit entries representing units of virtual currency or other currency alternatives of which a payment of an accounting system entry is, will be, was, or theoretically is composed. Currency alternative units include but are not limited to virtual currencies such as Bitcoin™, Linden Dollars™, QQ Coins™; and Facebook™ “Credits”. In some embodiments, currency alternative units further include inventory credit for bullion products as described herein.

As used herein, a “future value” comprises a future date and/or time and the value of a currency alternative unit at that future date and time based on a futures contract.

As used herein, “a non-volatile value” is a stable financial value of a currency alternative unit or federal reserve notes, other national currency notes, precious metal bullion units, legal tender bullion coins, other virtual currencies, a currency of a foreign jurisdiction, or units of a commercial commodity over a defined period of time. In some embodiments, a non-volatile value is established through the use of a futures contract.

Various embodiments of methods and apparatus for recording decomposition of accounting system entries are disclosed. In one embodiment, one or more processors are employed to perform recording a legal tender value of an accounting system entry in a currency and recording a legal tender decomposition of the accounting system entry in the currency.

As used herein, “legal tender decomposition” refers to an array of data values (elements) representing identities of coins and/or bank notes of which a payment of an accounting system entry is, will be, was, or theoretically is composed. In some embodiments, legal tender values of decomposition elements (e.g., made up of federal reserve notes and/or legal tender precious metal coins) of a legal tender decomposition sum to a total value of an accounting system entry in a particular currency.

As used herein, “identity of a coin” refers to a notation of a type of coin sufficient to identify a legal tender value and design standard weight and composition of the coin. Examples of an identity of a coin include, generally a coin name descriptor, denomination, and year (e.g., specifically, a 1986 $50 United States Gold Eagle). Examples of an identity of a coin further include, generally, a composition and value (e.g., specifically a USD $50 91.67% Au 3% Ag 5.33% Cu at 1 oz). Examples of an identity of a coin additionally include, generally a coin name descriptor, condition, denomination, and year (e.g., specifically, a 1986 $50 United States Gold Eagle in BU).

As used herein, “identity of a bank note” refers to a descriptor of a bank note sufficient to identify a denomination and currency of the bank note. In some embodiments, an identity of a bank note identifies the currency, denomination and source of the bank note. For example, a bank note could be identified as “Greek $20 twenty-euro note 2010” or “German twenty-euro note.”

As used herein, “federal reserve note” refers to a form of legal tender (e.g., system of identity of a bank note or coin) by which the legal tender value authorized by government is determined. At the time of this writing, the legal tender value of a federal reserve note controls valuation of the federal reserve note independent of composition value.

As used herein, “legal tender precious metal coins” refers to a form of legal tender (e.g., system of identity of a coin) by which the legal tender value authorized by government is determined, wherein there is a legal tender value distinct from any material value or composition value. More specifically, in some embodiments, there is a simultaneously different tax treatment for the legal tender value (i.e. ordinary income) vs. its material value, the tax treatment of which may be considered that of a collectible asset and therefore entitled to capital gains tax treatment.

As used herein, “legal tender value” refers to a value of a coin or bank note in a currency as set by government dependent on identity of the bank note or identity of the coin.

As used herein, “composition value” refers to a value of a coin dependent on a material value of a metal composition of a coin. In some embodiments, composition value depends on a date or location of transaction or may be uniformly agreed for purposes of a transaction or series of transactions.

As used herein, “dual-treatment aggregate value” refers to a value of a transaction based on composition value and variable tax treatment between a legal tender value and a composition value.

As used herein, “material value” refers to a value of a coin based on a current spot prices of the materials of which the coin is composed.

As used herein, a financial transaction is an event or condition under the contract between a buyer and a seller to exchange an asset for payment. A financial transaction represents a change in the status of the finances of two or more businesses or individuals, including but not limited to purchases, loans, mortgages, bank accounts, credit card transactions, debit card transactions.

As used herein, a valuation is a monetary value assigned to one or more items of collateral based on a set of assumptions.

Some embodiments include a system for recording decomposition of accounting system entries. In one embodiment, such a system may include a processor and a memory comprising program instructions. In some embodiments, the program instructions are executable by the at least one processor to record a legal tender value of an accounting system entry in a currency and record a legal tender decomposition of the accounting system entry in the currency.

Some embodiments may include a decomposition tracking module for recording decomposition of accounting system entries. The recording decomposition of accounting system entries may in some embodiments be implemented by a non-transitory, computer-readable storage medium and one or more processors (e.g., CPUs and/or GPUs) of a computing apparatus. The computer-readable storage medium may store program instructions executable by the one or more processors to cause the computing apparatus to perform recording a legal tender value of an accounting system entry in a currency and recording a legal tender decomposition of the accounting system entry in the currency.

Example applications of embodiments vary from accounting and finance to law enforcement. In one embodiment, as described below, an accounting system entry includes a legal tender value of the accounting system entry and a legal tender decomposition of the accounting system entry. In some embodiments, the accounting system entry further includes a time stamp. Some embodiments perform the calculation of a composition value from the legal tender decomposition. Using the computation value calculated from the legal tender decomposition, some embodiments support tracking, management, and reporting of financial transactions such as loans, option agreements, hedge contracts, futures contracts, and/or payments timed to maximize transaction value and/or minimize taxation using conversion between legal tender value and payments based on time-variable composition value.

### Application of Embodiments to Support for Financial Transaction

Some embodiments of systems and methods for recording decomposition of accounting system entries are usable for supporting transactions in which the value of the transaction is based, at least in part, on an alternative currency unit decomposition or the legal tender decomposition of coins used to provide payment.

Over the last thirty years, Congress has exercised its power under Article I, Section 8, Clause 5 of the United States Constitution by instructing the US Mint to produce precious metal (e.g., gold, silver, platinum, palladium, etc.) coins as legal tender. These coins have a legal tender value set by Congress that is distinct and, at market prices prevailing at the time of this filing, much lower than the material value of the precious metal content that makes up the coins. Despite the fact that these coins have a “face value” (i.e., legal tender value) that is much lower than their material value (i.e., the value of the precious metals that make up the coins), the law is clear that the monetary value of the coins is their legal tender value.

Legal tender is legally defined in 31 U.S.C. §5103, which states that United States coins and currency (including Federal reserve notes and circulating notes of Federal reserve banks and national banks) are legal tender for all debts, public charges, taxes, and dues. Foreign gold or silver coins are not legal tender for debts. The monetary value of these coins is distinct from their material value. For example, the case of Ling Su Fan v. United States (218 U.S. 302 (1910)) is read to establish the legal distinction of a coin bearing the “impress” of the sovereign, asserting that public law gives to such coinage a value which does not attach as a mere consequence of intrinsic value. Their quality as a legal tender is an attribute of law aside from their bullion value. They bear, therefore, the impress of sovereign power which fixes value and authorizes their use in exchange. The case of Thompson v. Butler (95 U.S. 694, 696 (1877)) is read to establish that the law makes no legal distinction between the values of coin and paper money used as legal tender, stating that a “coin dollar is worth no more for the purposes of tender in payment of an ordinary debt than a note dollar. The law has not made the note a standard of value any more than coin. It is true that in the market, as an article of merchandise, one is of greater value than the other; but as money, that is to say, as a medium of exchange, the law knows no difference between them.”

As recently as 2008, the courts have affirmed this distinction between legal tender value and material value. In Crummey v. Klein Independent School District, the Fifth Circuit Court of Appeals heard a case in which Brent E. Crummey brought a lawsuit complaining that two employees of the KISD tax office declined to accept Crummey's fifty-dollar United States American Eagle gold coins for any more than the face value of the coins in Federal Reserve Note dollars as tender in payment for taxes Crummey owed. The Fifth Circuit stated that, “[r]egardless of any currency confusion that may have arisen in bygone eras, our present standard is clear: As legal tender, a dollar is a dollar.” They further stated that: “As legal tender, a dollar is a dollar, regardless of the physical embodiment of the currency.”

The Internal Revenue Service (IRS) has held that while these coins have a legal tender value, for tax purposes legal tender precious metal coins are considered a collectible item. If they are held for more than one year and then sold, any profits (from any changes in the value of the precious metals) are taxed at a 28% collectibles capital gains tax rate. If they are held less than one year and then sold, any profits are taxed as ordinary income.

The IRS has also advised people that if a US Mint gold coin is used as legal tender (utilizing its face value) and then is later sold for its precious metal value, capital gains taxes (at the collectible rate) would be owed based upon the difference between the sales price minus the basis, which would be the face value of the coin.

Some embodiments support transactions, in which individuals may seek to legally reduce the taxes they pay in some transactions by recording the decomposition of an accounting entry recording receipt of a payment for later use in calculating capital gains taxation on the sale of metal coins which were received as the original payment. Such embodiments provide support for accounting useful in taking advantage of the fact that a US Mint precious metal coin can be used for its face value in a first stage of a transaction (purchase or acquisition), and when the recipient later sells the coin for its precious metal value, the tax owed may be calculated at the collectible capital gains taxes on the difference between the face value and the sales price. These capital gains taxes could be significantly lower than the taxes that might have otherwise been owed had the transaction not occurred with a US Mint precious metal coin. As used herein, a transaction in which capital gains tax treatment with respect to the difference between the composition value and the legal tender value of a coin is reported is an embodiment of a “dual-treatment aggregate value” transaction.

Some embodiments for recording the decomposition of an accounting entry support transactions for enabling some forms of taxed transactions (e.g. estate, income, inheritance, gift, etc.) to enjoy treatment at lower tax rate (e.g., capital gains rate) by using US Mint precious metal coins as a vehicle for splitting the taxes into two categories—the original tax category based upon the legal tender value of the US Mint precious metal coins (e.g. estate taxes, income taxes, inheritance taxes, gift taxes, etc.) and capital gains taxes at the collectible capital gains tax rate to achieve a “dual-treatment aggregate value” transaction.

As an example of a transaction supported by some embodiments for recording the decomposition of an accounting entry, consider an example of a parent seeking to give a child a cash gift. There is a currently gift tax exemption of $13,000 per year. A parent could give the child 260 one-ounce $50 American Gold Eagle coins with a face value of $13,000, recording an accounting system entry containing both a legal tender value of the accounting system entry ($13,000) and a legal tender decomposition of the accounting system entry (260 one-ounce $50 American Gold Eagle coins). Assuming the child holds the coins for more than one year, which some embodiments support by recording dates of transactions, and then sells them at $1,000 per ounce, the child would realize a capital gain of $247,000 ($260,000 minus the $13,000 basis). The child would owe a collectible capital gains tax of 28% of the $247,000 gained—but that amount would be significantly less then the ordinary income tax rate the child would have had to have paid on the $247,000 had it been given directly to the child as income. Some embodiments for recording the decomposition of an accounting entry support management of a transaction similar to this example. Additionally, some embodiments support financial transactions that allow for pre-payment of transaction cash flows by an institution holding coins for a party to such a transaction.

As an example of another transaction supported by some embodiments for recording the decomposition of an accounting entry, consider an example of an individual who may wish to reduce the 55% estate tax (or “death tax”) that they would pay when passing an estate of $60 million on to their heirs. Assume that the market price of gold is $1000/oz. By purchasing 60,000 one-ounce $50 American Gold Eagle coins with a face value of $3 million, the estate would transfer to the heirs without paying the 55% estate tax which exempts the first $3 million transferred. If the heirs held the 60,000 coins for at least one year and then sold them at $1,000 per ounce, they would owe a 28% tax on the $57 million in capital gains that was made, thus saving 27% taxes on the original $60 million estate (a tax savings of $16.2 million). Some embodiments for recording the decomposition of an accounting entry support management of a transaction similar to this example.

In some embodiments, accounting system entries are tracked in order to record the dates of transactions, the amount of the transactions in dollars (legal tender value) and the legal tender decomposition in US Mint precious metal coins. Some embodiments additionally record or are designed to query from a database the spot price of the precious metals at the date and time of any transactions, such that the number and type of US Mint precious metal coins can be used to calculate the taxes owed. Some embodiments further facilitate collections, payment, and reporting to taxing authorities, as well as loans, derivative contracts, futures contracts, option agreements, secured transactions, and payment streams tied to the legal tender decompositions of accounting entries.

Even more recently, the rise of virtual currencies has created similar opportunities. Digital currency, among its various names, is electronic money that acts as alternative currency. Currently, alternative digital currencies are not produced by government-endorsed central banks nor necessarily backed by national currency. Digital currency, such as Bitcoin™, are examples of currency alternative units. Bitcoin is not the only digital currency, nor the only successful one. Gamers on Second Life™, a virtual world, pay with Linden Dollars™; customers of Tencent™, a Chinese internet giant, deal in QQ Coins™; and Facebook™ sells “Credits”. What makes Bitcoin™ different is that, unlike other online (and offline) currencies, it is neither created nor administered by a single authority such as a central bank. Instead, new Bitcoins™ have to be “mined”, meaning users can acquire them by having their computers compete to solve complex mathematical problems (the winners get the virtual cash). The coins themselves are simply strings of numbers. They are thus a completely decentralised currency: a sort of digital gold. Businesses have started to accept Bitcoins™. Among them are Reddit™, a social-media site, and WordPress™, which provides web hosting and software for bloggers. The appeal for merchants is strong. Firms such as BitPay™ offer spot-price conversion into dollars. Fees are typically far less than those charged by credit-card companies or banks, particularly for orders from abroad. And Bitcoin™ transactions cannot be reversed, so frauds cannot leave retailers out of pocket. Problems arise, however, in stabilizing the fluctuating value of bitcoins for use in transactions conducted in a world dominated by legal tender currencies. Some embodiments address these issues with futures contracts and other derivatives transactions.

Notes with Respect to the Discussion of Embodiments

In the detailed description included herein, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities.

Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

### Example Implementations

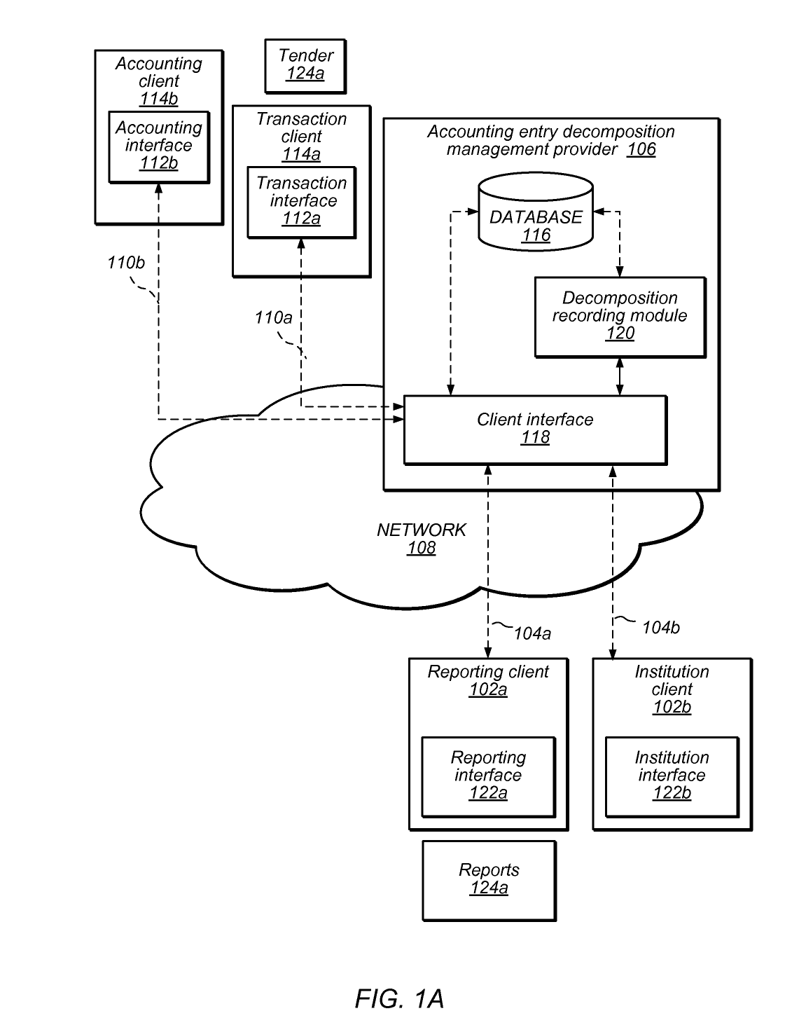

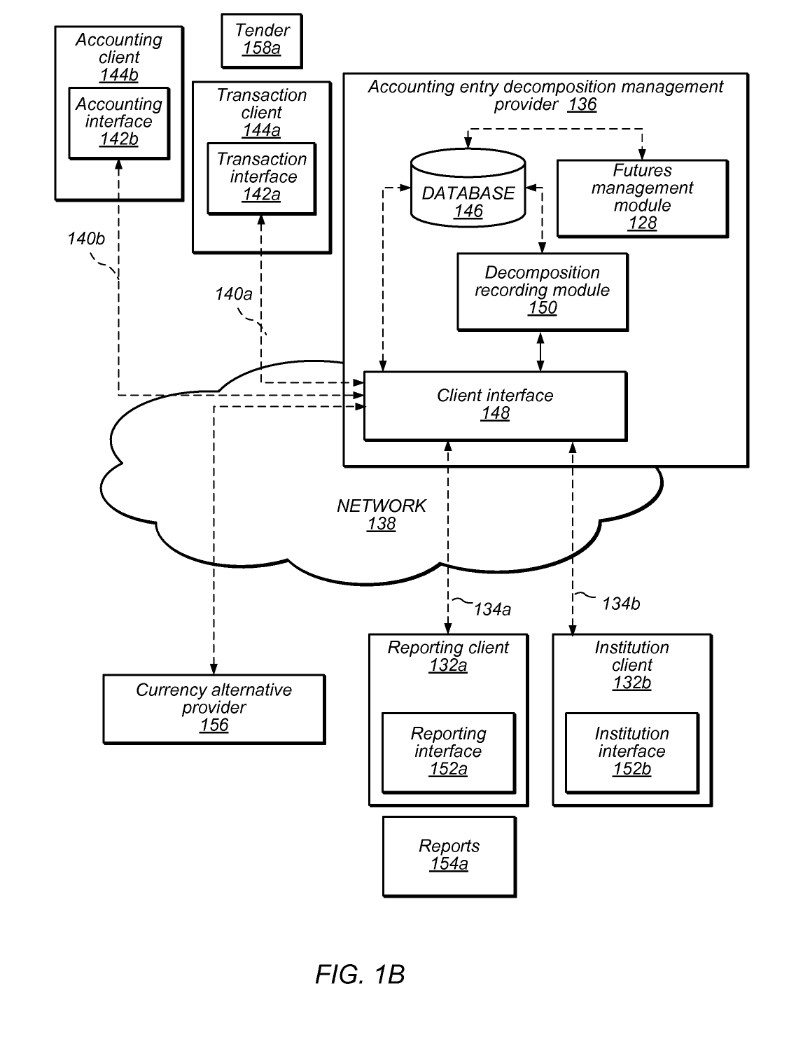

FIG. 1A illustrates a system architecture for recording decomposition of accounting system entries, according to some embodiments. In some embodiments, an accounting entry decomposition management provider 106 performs functions for tracking, managing and reporting transactions in which transaction value is based, at least in part, on recorded legal tender decompositions of accounting entries in a currency, as described herein. In some embodiments, a decomposition recording module 120 executes instructions for recording a legal tender value of an accounting system entry and recording a legal tender decomposition of the accounting system entry. Additionally, in some embodiments, a client interface 118 is used for receiving accounting entry data and reporting the legal tender decomposition of the accounting system entry and the legal tender value of the decomposition, such as over a network 108.

In some embodiments, the accounting entry data includes data 104b received over client interface 118 from institution client 102b, such as terms and conditions of transactions (e.g., loans, payments, cash advances, credit cards, article 9 secured transactions on gold in an inventory, lines of credit, article 3 credit instruments, or debit transactions), supported using accounting system entries including both a legal tender value of the accounting system entry and a legal tender decomposition of the accounting system entry. In some embodiments, the accounting entry data includes data 104b that is received using an institution interface 122b such as a teller's data entry screen or an account manager's data entry screen in the offices of a financial institution (e.g., bank, brokerage house, credit union).

In some embodiments, client interface 118 is used for providing accounting system entries for reports or reporting the legal tender decomposition of the accounting system entry and the legal tender value of the decomposition, such as over a network 108. In some embodiments, the report data includes data 104a is sent over client interface 118 to reporting client 102a, such as accounting entries representing aspects of transactions (e.g., values of loans, payments, cash advances, credit cards, article 9 secured transactions on gold in an inventory, lines of credit, article 3 credit instruments, or debit transactions), for use in reports 124a supported using accounting system entries including both a legal tender value of the accounting system entry and a legal tender decomposition of the accounting system entry. In some embodiments, such reports 124a include accounting system entries including both a legal tender value of the accounting system entry and a legal tender decomposition of the accounting system entry. In some embodiments, only legal tender values for transactions are reported in certain reports 124a. Likewise, in some embodiments, only legal tender decompositions are reported in certain reports 124a. Examples of such transactions are discussed herein. In some embodiments, the reporting data includes data 104a that is reported over a reporting interface 122a such as a teller's data entry screen or an account manager's data entry screen in the offices of a financial institution (e.g., bank, brokerage house, credit union). In other embodiments, reporting client data includes data 104a that is reported over a reporting interface 122a such as a web client on an end user interface. In some embodiments, reports 124a are screen displays or audio provided to a user. In other embodiments, reports 124a are printed paper statements and receipts.

In some embodiments, institution client 102b is a system for interacting with accounting entry decomposition management provider 106 that is used by recipients and providers of payments described in accounting system entries including a legal tender value of the accounting system entry and a legal tender decomposition of the accounting system entry.

In some embodiments, institution client 102b is a system for interacting with accounting entry decomposition management provider 106 that is used by precious metal tender warehouses for handling transactions described in accounting system entries including a legal tender value of the accounting system entry and a legal tender decomposition of the accounting system entry.

In some embodiments, institution client 102a and reporting client 102b are systems for professional services companies involved in facilitating accounting reporting, tax calculation, and/or transaction reporting to users of transactions supported by an operator of accounting entry decomposition management provider 106.

In some embodiments, a transaction client 114a is a system for receiving or dispensing tender, such as an automatic teller (ATM) machine, represented by accounting system entries including a legal tender decomposition of the accounting system entry, and, optionally, a legal tender value of the accounting system entry. In some embodiments, data 110a containing accounting system entries including a legal tender decomposition of the accounting system entry is forwarded as data 104a-104b to accounting entry decomposition management provider 106 and then to reporting client 102a for reporting of the legal tender decomposition of the accounting system entry and the legal tender value of the decomposition. In some embodiments, data 110a represents payments received as tender 126a comprising both bank notes and legal tender precious metal coins. In some embodiments, a transaction interface 112a is provided for allowing a user to provide details of the transaction. In some embodiments, transaction client 114a is able to analyze tender 124a to determine the legal tender decomposition of tender 124a.

In some embodiments, data 110a may include accounting reports of various aspects of accounting system entries including a legal tender decomposition of the accounting system entry, and, optionally, a legal tender value of the accounting system entry. In some embodiments, an amount of a current payment received or requested as tender 124a is based at least in part upon accounting system entries including a legal tender decomposition of the accounting system entry, and, optionally, a legal tender value of the accounting system entry. Various data 110a-110b and data 104a-104b may be stored in a database 116 for tracking, managing and reporting transactions based at least in part upon accounting system entries including a legal tender decomposition of the accounting system entry, and, optionally, a legal tender value of the accounting system entry.

In some embodiments, an accounting client 114b is a system for interacting with accounting entry decomposition management provider 106 that is used by end users of with accounting entry decomposition management provider 106 to record a legal tender decomposition of the accounting system entry, and record a legal tender value of the accounting system entry. In some embodiments, data 110b containing a legal tender decomposition of the accounting system entry and a legal tender value of the accounting system entry may be forwarded to reporting client 102a as data 104a for reporting or to institution client 102b to indicate an order for a financial transaction, thereby facilitating payment or transaction processing. In some embodiments, data 110b may include accounting reports of various aspects of transactions including a legal tender decomposition of an accounting system entry and a legal tender value of the accounting system entry.

An example of one embodiment of a transaction supported as described herein follows. A user of a transaction client 114a may approach transaction client 114a and submit tender 124a for deposit in an account managed by a financial institution using accounting entry decomposition management provider 106. Accounting system entries are transmitted to client interface 118a over network 108a as data 110a. Accounting entry decomposition management provider 106 records to database 116 a legal tender decomposition of an accounting system entry and a legal tender value of the accounting system entry, where the entry represents tender 124a. Accounting entry decomposition management provider 106 reports a legal tender decomposition of the accounting system entry and the legal tender value of the accounting system entry as data 104b to institution client 102b for use with institution interface 122b at a financial institution, such as a bank, that supports precious metal banking accounts. Accounting entry decomposition management provider 106 reports a legal tender decomposition of the accounting system entry and the legal tender value of the accounting system entry as data 104a to reporting client 102a for use with reporting interface 122a at a professional services provider, such as an accountancy, for preparing tax reports based on the legal tender decomposition of the accounting system entry and the legal tender value of the accounting system entry.

Accounting entry decomposition management provider 106 reports a legal tender decomposition of the accounting system entry and the legal tender value of the accounting system entry as data 110b to accounting client 112b for use with accounting interface 122a at a user terminal, such as a business accounting software package, for preparing reports such as balance sheets and cash flow based on the legal tender decomposition of the accounting system entry and the legal tender value of the accounting system entry.

FIG. 1B illustrates a system architecture for recording decomposition of accounting system entries, according to some embodiments. In some embodiments, an accounting entry decomposition management provider 136 performs functions for tracking, managing and reporting transactions in which transaction value is based, at least in part, on recorded currency alternative unit decompositions of accounting entries in a currency, as described herein. Examples of currency alternatives include gold bullion coins and virtual currencies, as described herein. In some embodiments, a decomposition recording module 150 executes instructions for recording a legal tender value of an accounting system entry and recording a currency alternative unit decomposition of the accounting system entry. Additionally, in some embodiments, a client interface 148 is used for receiving accounting entry data and reporting the currency alternative unit decomposition of the accounting system entry and the legal tender value of the decomposition, such as over a network 138.

In some embodiments, the accounting entry data includes data 134b received over client interface 148 from institution client 132b, such as terms and conditions of transactions (e.g., loans, payments, cash advances, futures contracts, credit cards, article 9 secured transactions on bitcoin, other virtual currencies, or gold or other tangible commodities registered in an accounting system, lines of credit, article 3 credit instruments, or debit transactions), supported using accounting system entries including both a legal tender value of the accounting system entry and a currency alternative unit decomposition of the accounting system entry. In some embodiments, the accounting entry data includes data 134b that is received using an institution interface 152b such as a teller's data entry screen or an account manager's data entry screen in the offices of a financial institution (e.g., bank, brokerage house, credit union).

In some embodiments, client interface 148 is used for providing accounting system entries for reports or reporting the currency alternative unit decomposition of the accounting system entry and the legal tender value of the decomposition, such as over a network 138. In some embodiments, the report data includes data 134a is sent over client interface 148 to reporting client 132a, such as accounting entries representing aspects of transactions (e.g., values of loans, payments, futures contracts, cash advances, credit cards, article 9 secured transactions on gold in an inventory, lines of credit, article 3 credit instruments, or debit card transactions), for use in reports 154a supported using accounting system entries including both a legal tender value of the accounting system entry and a currency alternative unit decomposition of the accounting system entry. In some embodiments, such reports 154a include accounting system entries including both a legal tender value of the accounting system entry and a currency alternative unit decomposition of the accounting system entry. In some embodiments, only legal tender values for transactions are reported in certain reports 154a. Likewise, in some embodiments, only legal tender decompositions are reported in certain reports 154a. Examples of such transactions are discussed herein. In some embodiments, the reporting data includes data 134a that is reported over a reporting interface 152a such as a teller's data entry screen or an account manager's data entry screen in the offices of a financial institution (e.g., bank, brokerage house, credit union). In other embodiments, reporting client data includes data 134a that is reported over a reporting interface 152a of a reporting client 132a such as a web client on an end user interface. In some embodiments, reports 154a are screen displays or audio provided to a user. In other embodiments, reports 154a are printed paper statements and receipts.

In some embodiments, institution client 132b is a system for interacting with accounting entry decomposition management provider 136 that is used by recipients and providers of payments described in accounting system entries including a legal tender value of the accounting system entry and a currency alternative unit decomposition of the accounting system entry.

In some embodiments, institution client 132b is a system for interacting with accounting entry decomposition management provider 136 that is used in conjunction with a currency alternative provider 156 (e.g., a virtual currency or precious metal tender warehouses) for handling transactions described in accounting system entries including a legal tender value of the accounting system entry and a currency alternative unit decomposition of the accounting system entry.

In some embodiments, institution client 132a and reporting client 132b are systems for professional services companies involved in facilitating accounting reporting, tax calculation, and/or transaction reporting to users of transactions supported by an operator of accounting entry decomposition management provider 136.

In some embodiments, a transaction client 144a is a system for receiving or dispensing receipts for actual tender 158a, such as an automatic teller (ATM) machine, of representations of accounting system entries including a currency alternative unit decomposition of the accounting system entry, and, optionally, a legal tender value of the accounting system entry. In some embodiments, data 140a containing accounting system entries including a currency alternative decomposition of the accounting system entry is forwarded as data 144a-144b to accounting entry decomposition management provider 136 and then to reporting client 132a for reporting of the currency alternative unit decomposition of the accounting system entry and the legal tender value of the decomposition. In some embodiments, data 140a represents payments received as tender 158a comprising any or all of bank notes, virtual currency or other currency alternative units and legal tender precious metal coins. In some embodiments, a transaction interface 142a is provided for allowing a user to provide details of the transaction. In some embodiments, transaction client 144a is able to analyze tender 158a to determine the currency alternative unit decomposition of tender 158a.

In some embodiments, data 140a may include accounting reports of various aspects of accounting system entries including a currency alternative unit decomposition of the accounting system entry, and, optionally, a legal tender value of the accounting system entry. In some embodiments, an amount of a current payment received or requested as tender 158a is based at least in part upon accounting system entries including a legal tender decomposition of the accounting system entry, and, optionally, a legal tender value of the accounting system entry. Various data 140a-140b and data 134a-134b may be stored in a database 146 for tracking, managing and reporting transactions based at least in part upon accounting system entries including a currency alternative unit decomposition of the accounting system entry, and, optionally, a legal tender value of the accounting system entry.

In some embodiments, an accounting client 144b is a system for interacting with accounting entry decomposition management provider 136 that is used by end users of with accounting entry decomposition management provider 136 to record a currency alternative unit decomposition of the accounting system entry, and record a legal tender value of the accounting system entry. In some embodiments, data 140b containing a currency alternative unit decomposition of the accounting system entry and a legal tender value of the accounting system entry may be forwarded to reporting client 132a as data 134a for reporting or to institution client 132b to indicate an order for a financial transaction, thereby facilitating payment or transaction processing, for example using a debit card. In some embodiments, data 140b may include accounting reports of various aspects of transactions including a currency alternative unit decomposition of an accounting system entry and a legal tender value of the accounting system entry.

An example of one embodiment of a transaction supported as described herein follows. A user of a transaction client 144a may approach transaction client 144a and submit tender 158a for deposit in an account managed by a financial institution using accounting entry decomposition management provider 136. Accounting system entries are transmitted to client interface 148 over network 138 as data 140a. Accounting entry decomposition management provider 136 records to database 146 a currency alternative unit decomposition of an accounting system entry and a legal tender value of the accounting system entry, where the entry represents tender 158a. Accounting entry decomposition management provider 136 reports a legal tender decomposition of the accounting system entry and the legal tender value of the accounting system entry as data 134b to institution client 132b for use with institution interface 132b at a financial institution, such as a bank, that supports precious metal banking accounts, bitcoin accounts, and debit cards representing future values of bitcoins or metal calculated using a futures management module 128. Some currency alternative unit transactions are supported by a currency alternative provider 156, such as a virtual currency company. Accounting entry decomposition management provider 136 reports a currency alternative unit decomposition of the accounting system entry and the legal tender value of the accounting system entry as data 134a to reporting client 132a for use with reporting interface 132a at a professional services provider, such as an accountancy, for preparing tax reports based on the currency alternative unit decomposition of the accounting system entry and the legal tender value of the accounting system entry.

Accounting entry decomposition management provider 136 reports a currency alternative unit decomposition of the accounting system entry and the legal tender value of the accounting system entry as data 140b to accounting client 144b for use with accounting interface 142a at a user terminal, such as a business accounting software package, for preparing reports such as balance sheets and cash flow based on the currency alternative unit decomposition of the accounting system entry and the legal tender value of the accounting system entry.

In some embodiments, the decomposition recording module 150 performs recording in database 146 a legal tender value of an accounting system entry, and recording in database 146 a currency alternative unit decomposition of the accounting system entry. In some embodiments, the accounting system entry represents at least one or more currency alternative units associated with a financial transaction. In some embodiments, the futures management module 128 performs calculating a financial amount for the financial transaction utilizing at least the currency alternative unit decomposition of the accounting system entry. In some embodiments, the client interface 148 performs facilitating the financial transaction. In some embodiments, the futures management module 128 performs calculating a financial amount for the financial transaction utilizing at least the currency alternative unit decomposition of the accounting system entry by calculating a financial amount for the financial transaction utilizing at least the currency alternative unit decomposition representing an amount of virtual currency units.

In some embodiments, the client interface 148 facilitating the financial transaction further includes futures management module 128 calculating an expected future value of the currency alternative unit decomposition and providing access to funds representing the expected future value via a debit card. In some embodiments, the futures management module 128 calculating a financial amount for the financial transaction utilizing at least the currency alternative unit decomposition of the accounting system entry further includes futures management module 128 calculating a financial amount for the financial transaction utilizing at least the currency alternative unit decomposition representing an amount of legal tender bullion coins. In some embodiments, decomposition recording module 150 performs preparing a report of the financial transaction. The preparing the report further includes reporting the currency alternative unit decomposition and recording the financial transaction in a storage medium, such as database 146. In some embodiments, the decomposition recording module 150 performs reporting the currency alternative unit decomposition of the accounting system entry and the legal tender value of the accounting system entry. In some embodiments, decomposition recording module 150 performs calculating a composition value of the accounting system entry based at least in part on the currency alternative unit decomposition of the accounting system entry. The composition value is based at least in part on an algorithmic prediction of future supply from futures management module 128 or demand associated with the currency alternative unit.

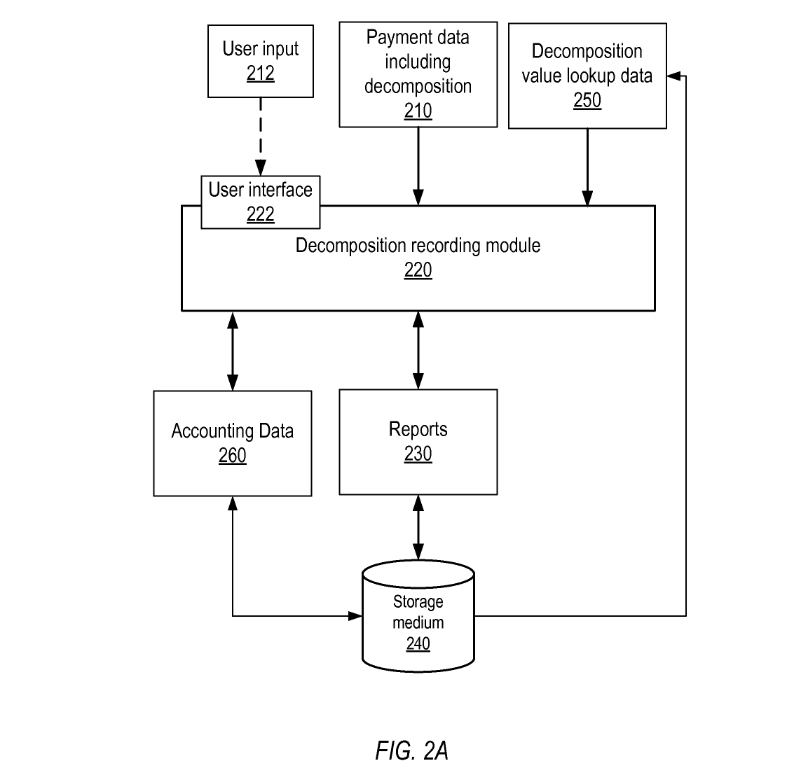

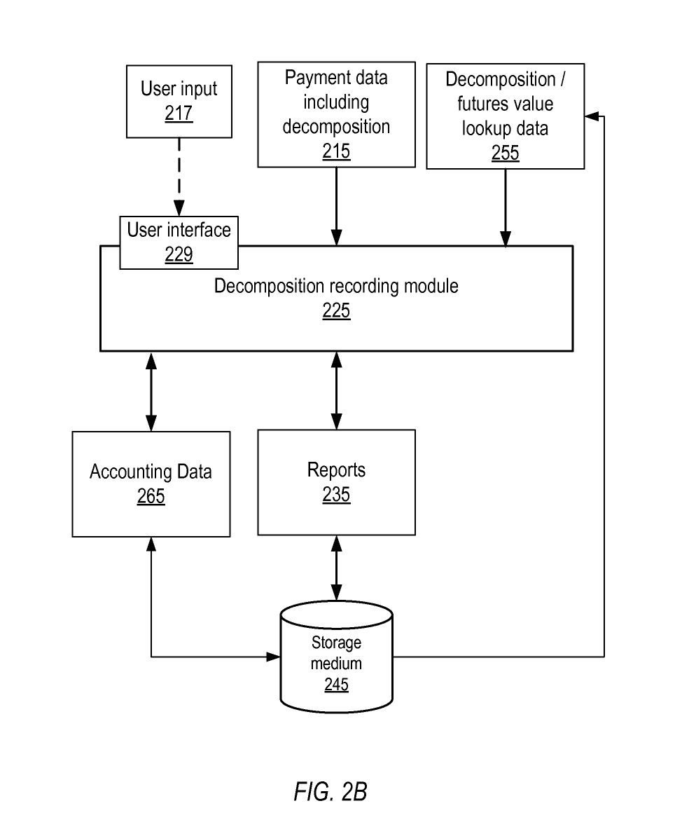

FIG. 2A depicts a module that that may be used for recording decomposition of accounting system entries, according to some embodiments. A decomposition recording module 220 includes instructions for, in some embodiments, recording a legal tender value of an accounting system entry and recording a legal tender decomposition of the accounting system entry.

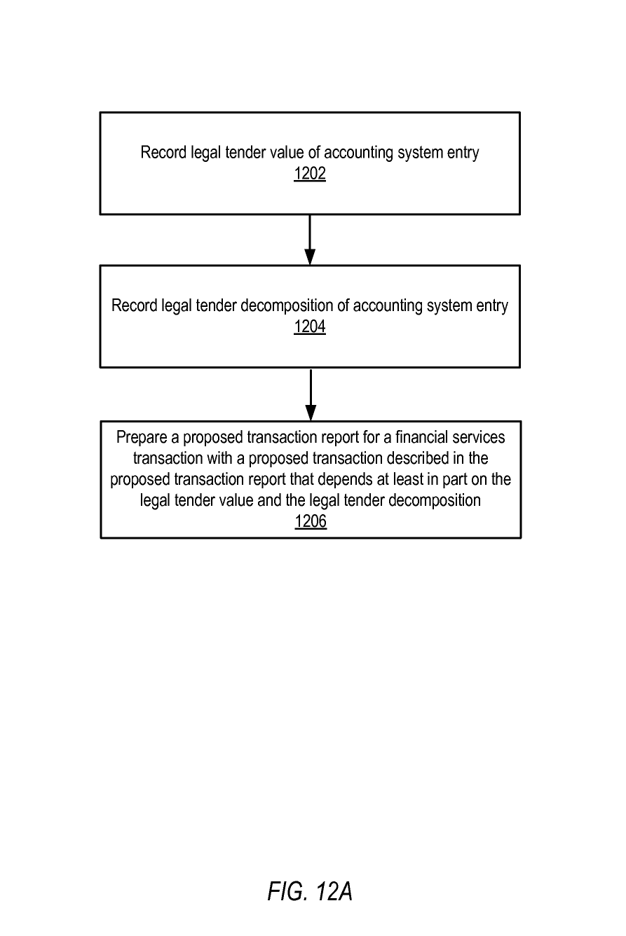

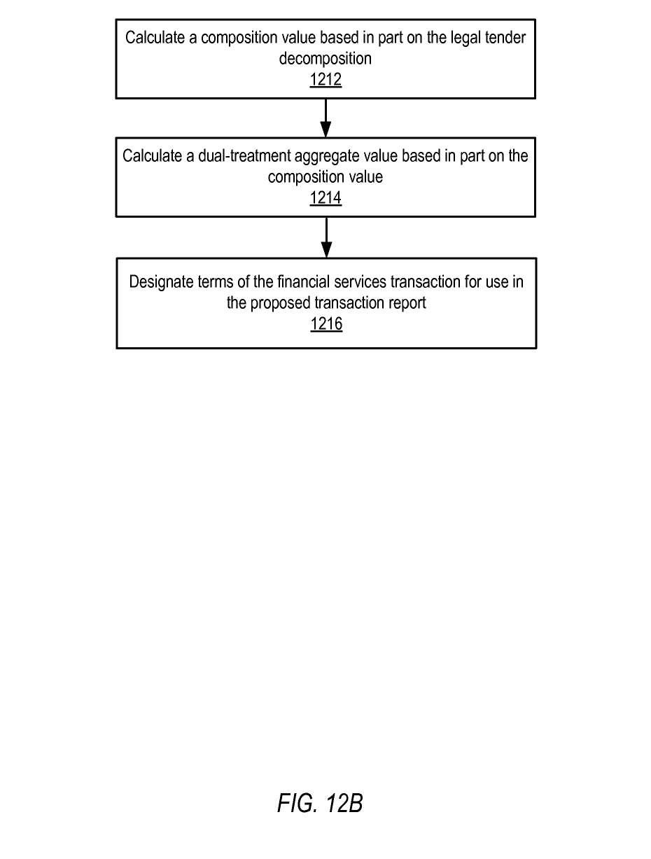

In some embodiments, decomposition recording module 220 implements one or more of a tool for calculating a composition value of the accounting system entry based at least in part on the legal tender decomposition of the accounting system entry or a tool for reporting the legal tender decomposition of the accounting system entry and the legal tender value of the decomposition. In some embodiments, decomposition recording module 220 implements tools for retrieving decomposition lookup data 250 including, in some embodiments either or both of, the composition of coins and the spot values (at various dates) of metals of which coins are composed. In some embodiments, decomposition recording module 220 receives payment data including decompositions from an accounting client, institution client, or transaction client. FIG. 12 illustrates an example computer system on which embodiments of decomposition recording module 220 may be implemented.

In some embodiments, decomposition recording module 220 receives as input one or more items of payment data including decompositions 210. Payment data 210 varies between embodiments. Examples include but are not limited to up/downloaded transaction statements, up/downloaded financial statements from a financial services provider, imported banking and transaction data directly from one or more remote bank accounts or financial institutions that provide banking services through a transaction interface, and manually entered decomposition information from an accounting client. Embodiments support data intake ranging from manual entry to automatic integrated decomposition support from transaction clients that electromechanically ascertain the identity of a coin or bank note, either through direct measurement of the coin or bank note or through electro-optically reading the identity of a “slabbed coin” from its casing. In some embodiments, decomposition recording module 220 is integrated within an accounting provider or accounting package. In other embodiments, decomposition recording module 220 operates as a stand-alone application on any of a wide range of computing systems, examples of which include but are not limited to systems including ATM machines, mainframes, personal desktop computers, cloud computing environments, hand-held computers and smartphones.

In some embodiments, decomposition recording module 220 may receive user input 212 indicating decompositions, providing payment instructions, providing metal prices, indicating terms and conditions of a transaction, or requesting tracking reports for transactions. Decomposition recording module 220 calculates transaction values based on composition information, tax rates, dates and transaction terms, which may include agreed or spot metal prices. In some embodiments, decomposition recording module 220 also detects and reports suspicious or prohibited transactions. Decomposition recording module 220 may receive information indicating payments received or price fluctuations. Decomposition recording module 220 updates accounting data 260 and provides reports 230 reflecting the tracking, management and reporting transactions. Accounting data 260 and reports 230 may, for example, be stored to a storage medium 240, such as system memory, a disk drive, DVD, CD, etc.

In some embodiments, decomposition recording module 220 may provide a user interface 222 via which a user may interact with the decomposition recording module 220, for example to set up terms and conditions of a transaction, report legal tender values and legal tender decompositions of account entries, arrange payments, and request reports. In some embodiments, the user interface may provide user interface elements whereby the user may select options including, but not limited to, fixed metal prices and tax rate preferences, loan and payment terms, and orders for financial transactions.

FIG. 2B depicts a module that that may be used for recording decomposition of accounting system entries, according to some embodiments. A decomposition recording module 225 includes instructions for, in some embodiments, recording a legal tender value of an accounting system entry and recording a currency alternative unit decomposition of the accounting system entry.

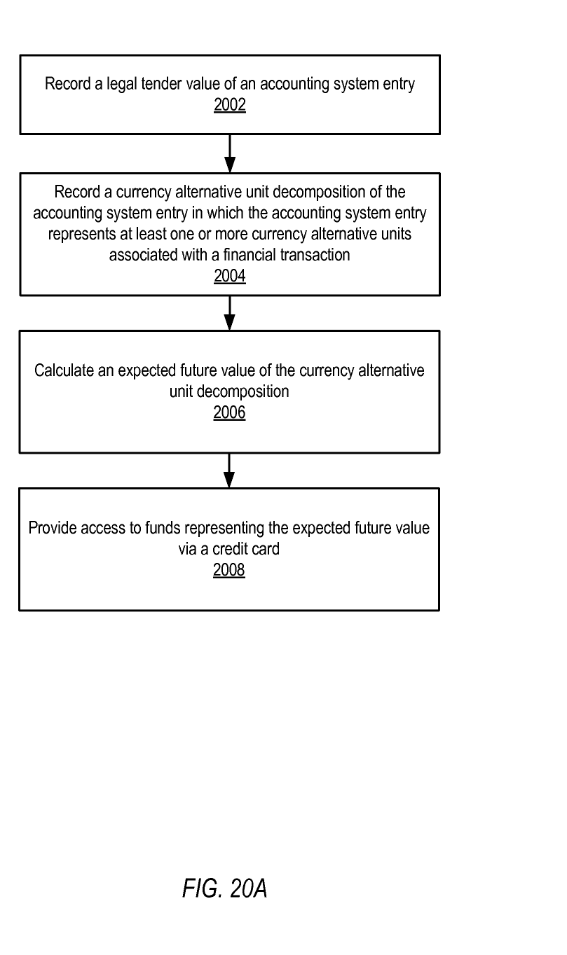

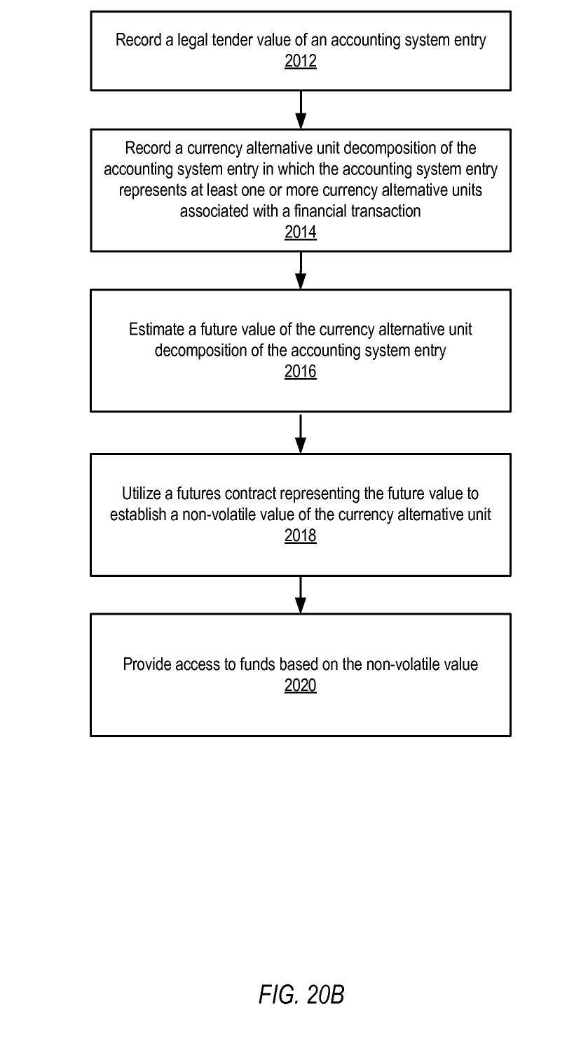

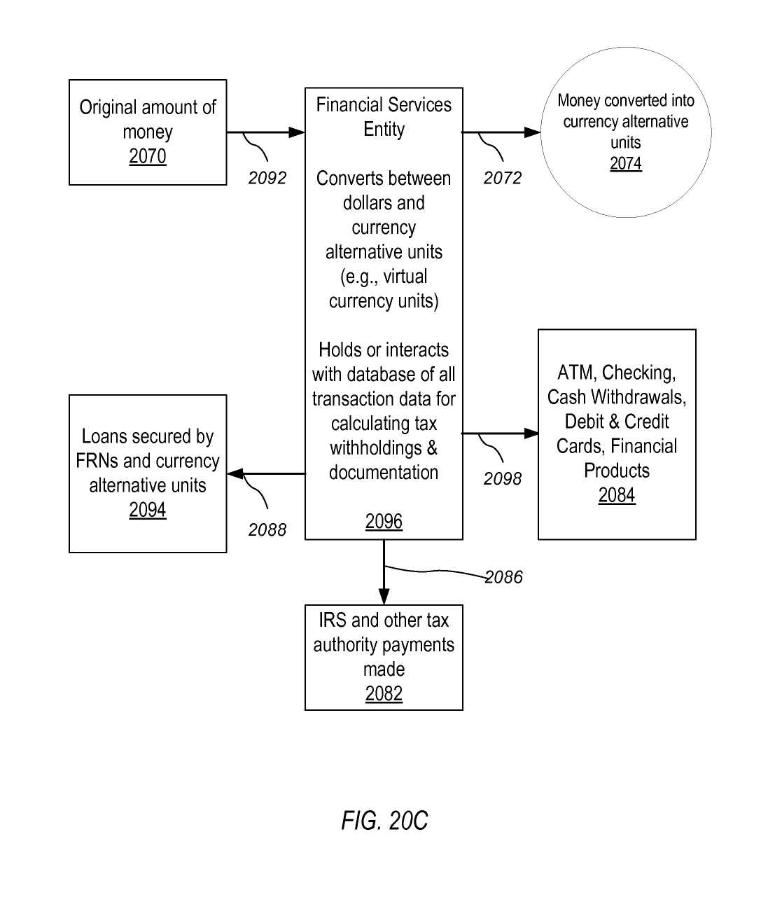

In some embodiments, decomposition recording module 225 implements one or more of a tool for calculating a futures-contract-linked value of the accounting system entry based at least in part on the currency alternative unit decomposition of the accounting system entry or a tool for reporting the legal tender decomposition of the accounting system entry and the legal tender value of the decomposition. In some embodiments, decomposition recording module 225 implements tools for retrieving decomposition and features value lookup data 255 including, in some embodiments either or both of, the composition of coins and the spot values (at various dates) of metals of which coins are composed, as well as spot and contract future values for virtual currencies or other currency alternative units. In some embodiments, decomposition recording module 225 receives payment data including decompositions from an accounting client, institution client, or transaction client. FIG. 20 illustrates an example computer system on which embodiments of decomposition recording module 225 may be implemented.

In some embodiments, decomposition recording module 225 receives as input one or more items of payment data including currency alternative unit decompositions 215. Payment data 215 varies between embodiments. Examples include but are not limited to up/downloaded transaction statements, debit card transaction data structures, up/downloaded financial statements from a financial services provider, imported banking and transaction data directly from one or more remote bank accounts or financial institutions that provide banking services through a transaction interface, and manually entered decomposition information from an accounting client. Embodiments support data intake ranging from manual entry to automatic integrated decomposition support from transaction clients that electromechanically ascertain the identity of a coin, virtual currency unit, or bank note, for example by receiving the numerical identity of a virtual currency unit. In some embodiments, decomposition recording module 225 is integrated within an accounting provider or accounting package. In other embodiments, decomposition recording module 225 operates as a stand-alone application on any of a wide range of computing systems, examples of which include but are not limited to systems including ATM machines, mainframes, personal desktop computers, cloud computing environments, hand-held computers and smartphones.

In some embodiments, decomposition recording module 225 may receive user input 217 at a user interface 229 indicating decompositions, providing payment instructions, providing currency alternative unit prices and futures contract terms, indicating terms and conditions of a transaction, or requesting tracking reports for transactions. Decomposition recording module 225 calculates transaction values based on composition information, tax rates, dates and transaction terms, which may include agreed or spot currency alternative prices. In some embodiments, decomposition recording module 225 also detects and reports suspicious or prohibited transactions. Decomposition recording module 225 may receive information indicating payments received or price fluctuations. Decomposition recording module 225 updates accounting data 265 and provides reports 235 reflecting the tracking, management and reporting transactions. Accounting data 265 and reports 235 may, for example, be stored to a storage medium 245, such as system memory, a disk drive, DVD, CD, etc.

In some embodiments, decomposition recording module 225 may provide a user interface 229 via which a user may interact with the decomposition recording module 225, for example to set up terms and conditions of a transaction, report legal tender values and currency alternative unit decompositions of account entries, arrange payments, and request reports. In some embodiments, the user interface may provide user interface elements whereby the user may select options including, but not limited to, fixed metal prices, virtual currency exchange prices, and tax rate preferences, loan and payment terms, and orders for financial transactions.

In some embodiments, decomposition recording module 225 records a legal tender value of an accounting system entry as accounting data 265 and records a currency alternative unit decomposition of the accounting system entry as accounting data 265. In some embodiments, the accounting system entry represents at least one or more currency alternative units associated with a financial transaction. In some embodiments, decomposition recording module 225 calculates a financial amount for the financial transaction utilizing at least the currency alternative unit decomposition of the accounting system entry. In some embodiments, decomposition recording module 225 performs facilitating the financial transaction. In some embodiments, decomposition recording module 225 calculates a financial amount for the financial transaction utilizing at least the currency alternative unit decomposition of the accounting system entry by calculating a financial amount for the financial transaction utilizing at least the currency alternative unit decomposition representing an amount of virtual currency units.

In some embodiments, decomposition recording module 225 facilitates the financial transaction by calculating an expected future value of the currency alternative unit decomposition and providing access to funds representing the expected future value via a debit card. In some embodiments, decomposition recording module 225 calculates a financial amount for the financial transaction utilizing at least the currency alternative unit decomposition of the accounting system entry by calculating a financial amount for the financial transaction utilizing at least the currency alternative unit decomposition representing an amount of legal tender bullion coins.

In some embodiments, decomposition recording module 225 prepares a report 235 of the financial transaction. The preparing the report 235 further includes reporting the currency alternative unit decomposition and recording the financial transaction in a storage medium. In some embodiments, decomposition recording module 225 reports the currency alternative unit decomposition of the accounting system entry and the legal tender value of the accounting system entry. In some embodiments, decomposition recording module 225 calculates a composition value of the accounting system entry based at least in part on the currency alternative unit decomposition of the accounting system entry. The composition value is based at least in part on an algorithmic prediction of future supply or demand associated with the currency alternative unit.

### Example Legal Tender Decompositions

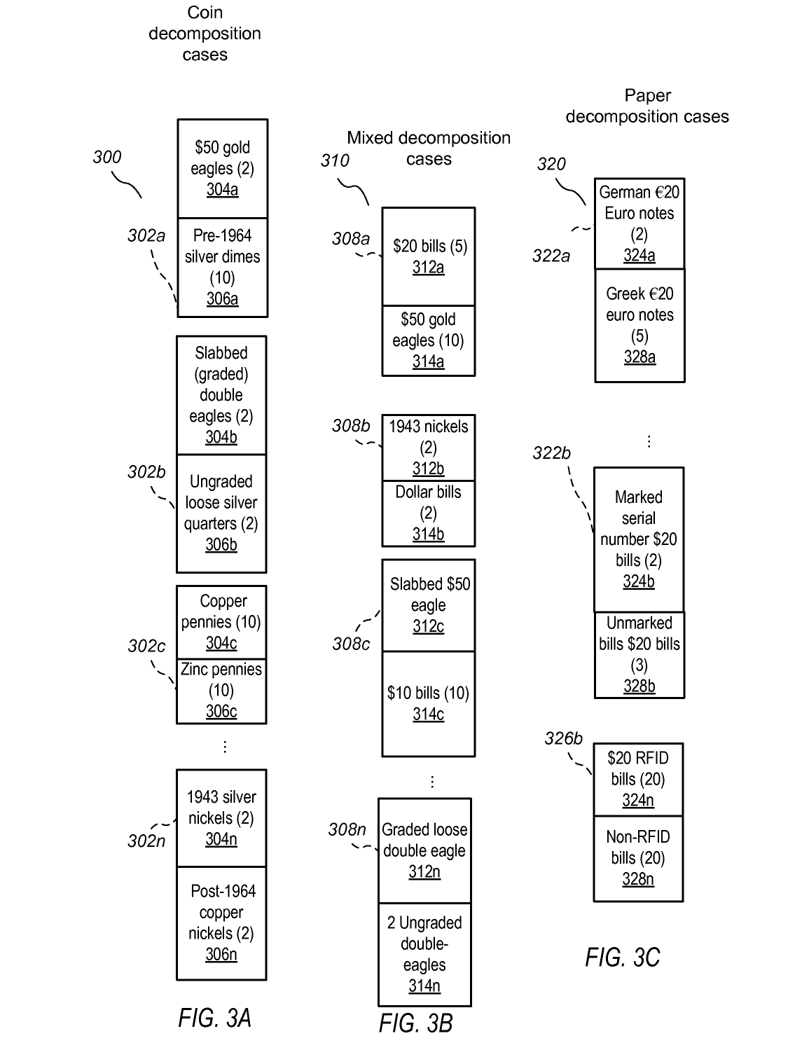

FIGS. 3A-3C illustrate a series of decompositions of accounting system entries that may be recorded, according to some embodiments. A series of coin decomposition cases 300 is provided in FIG. 3A. In a first case 302a, a decomposition of two $50 gold eagles 304a and ten pre-1964 silver dimes is recorded along with a legal tender value of $101.00. In a second case 302b, a decomposition of two $20 slabbed (graded) double eagles 304b and two pre-1964 silver quarters is recorded along with a legal tender value of $40.50. In a third case 302c, a decomposition of ten $0.01 copper pennies 304c and ten zinc pennies is recorded along with a legal tender value of $00.40. In an nth case 304n, a decomposition of two 1943 silver nickels 304n and two post-1964 copper nickels is recorded along with a legal tender value of $00.20.

A series of mixed decomposition cases 310 is provided in FIG. 3B. In a first case 308a, a decomposition of five $20 US bills 312a and ten $50 gold eagles is recorded along with a legal tender value of $500.00. In a second case 308b, a decomposition of two 1943 nickels 312b and two dollar bills is recorded along with a legal tender value of $2.10. In a third case 308c, a decomposition of one slabbed $50 gold eagle 312c and ten $10 bills 314c is recorded along with a legal tender value of $150.00. In an nth case 304n, a decomposition of a graded loose double eagle 312n and two ungraded loose double eagles 314n is recorded along with a legal tender value of $80.00.

A series of bill decomposition cases 320 is provided in FIG. 3C. In a first case 322a, a decomposition of two £20 German notes 324a and five £20 Greek notes 328a is recorded along with a legal tender value of £120. In a second case 322b, a decomposition of two marked (serial number, and the serial numbers are recorded) $20 bills 324b and three unmarked $20 dollar bills is recorded along with a legal tender value of $100. In an nth case 308c, a decomposition of twenty RFIDed $20 bills 324n and twenty non-RFIDed $20 bills 328n is recorded along with a legal tender value of $800.00. RFIDs are also recorded.

### Example Operations Usable by Some Embodiments

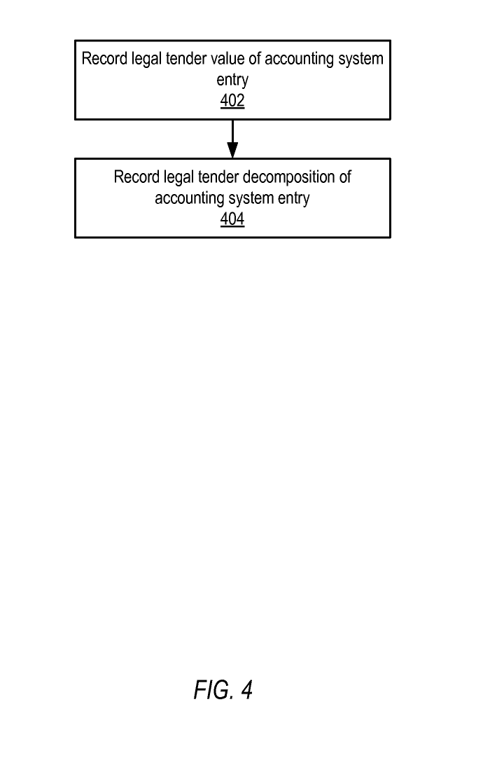

FIG. 4 is a high-level logical flowchart of operations usable for recording decomposition of accounting system entries, according to some embodiments. A legal tender value of an accounting system entry is recorded (block 402). In some embodiments, the legal tender value is recorded in a currency. A legal tender decomposition of the accounting system entry is recorded (block 404). In some embodiments, the legal tender value is recorded in the currency.

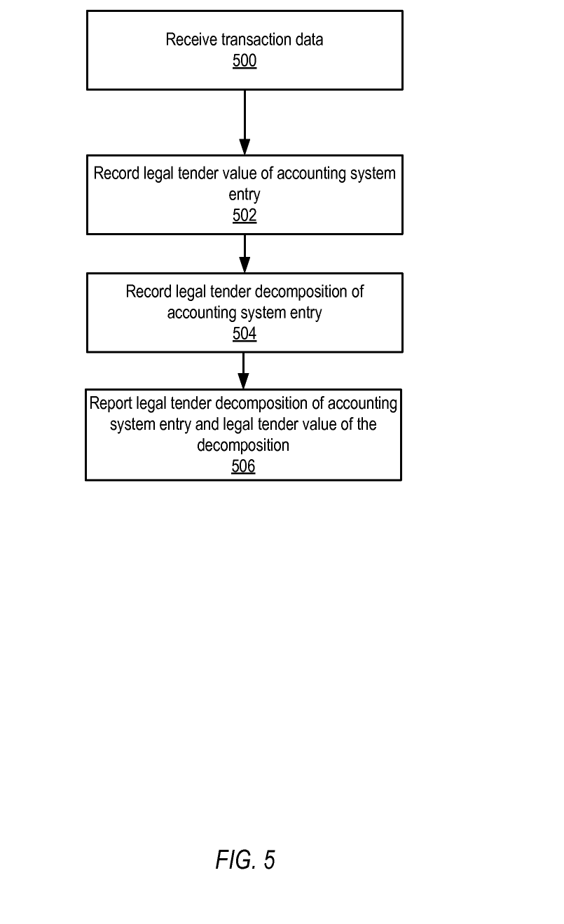

FIG. 5 is a high-level logical flowchart of operations that can be used for recording and reporting decomposition of accounting system entries, according to some embodiments. Transaction data is received (block 500). A legal tender value of an accounting system entry is recorded (block 502). In some embodiments, the legal tender value is included in the received transaction data. A legal tender decomposition of the accounting system entry is recorded (block 504). A legal tender decomposition of accounting system entry and a legal tender value of the decomposition are reported (block 506).

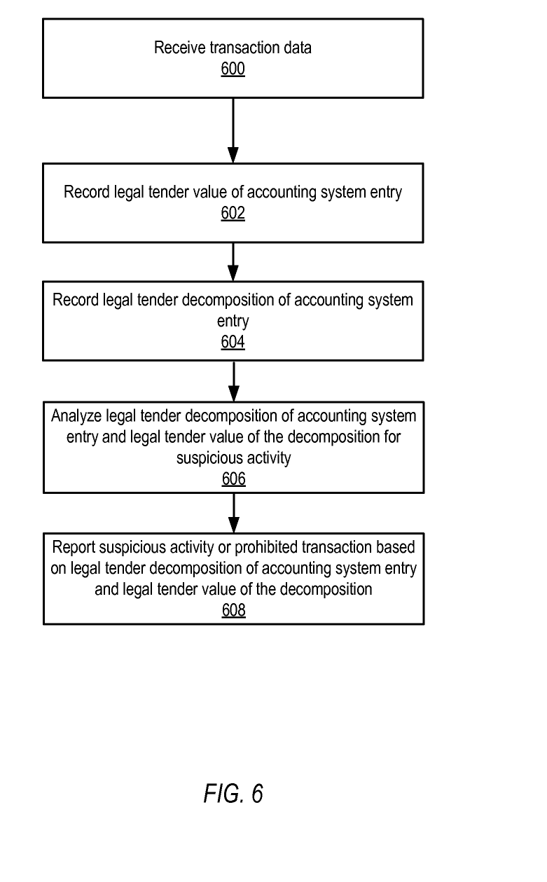

FIG. 6 is a high-level logical flowchart of operations that can be used for a law enforcement application of recording decomposition of accounting system entries, according to some embodiments. Transaction data is received (block 600). A legal tender value of an accounting system entry is recorded (block 602). In some embodiments, the legal tender value is recorded in a currency. A legal tender decomposition of the accounting system entry is recorded (block 604). The legal tender decomposition of accounting system entry and legal tender value of the decomposition are analyzed for suspicious activity (block 606). Suspicious activity or a prohibited transaction based is reported on legal tender decomposition of accounting system entry and legal tender value of the decomposition (block 608).

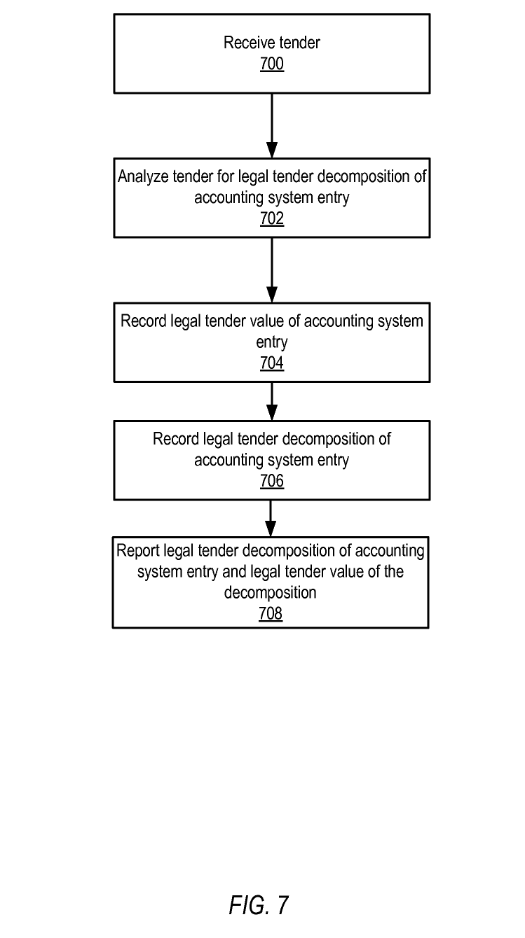

FIG. 7 is a high-level logical flowchart of operations that can be used for a fully mechanized recording of decomposition of accounting system entries, according to some embodiments. Tender is received (block 700). In some embodiments, tender is received through a transaction client, examples of which include automated teller machines and other similar transaction terminals. The tender for is analyzed for legal tender decomposition of accounting system entry (block 702). In some embodiments, analysis can include electromechanical analysis of a coin to determine identify or composition (e.g., based on dimensions, weight, conductivity, electromagnetic signature, or other measurable characteristics). In other embodiments, analysis can include identifying coins or bank notes with electro-optic sensors and pattern recognition software. In some embodiments, coins may be received in holders (slabs) with identifying information provided on the coin. Likewise, banknotes may be analyzed electro-optically in some embodiments or through an radio-frequency identifier inserted within the banknote. Alternative embodiments substitute entry by a bank teller of the legal tender decomposition for the analysis operation.

Legal tender value of accounting system entry is recorded (block 704). Legal tender decomposition of the accounting system entry is recorded (block 706). Legal tender decomposition of accounting system entry and legal tender value of the decomposition are reported (block 708).

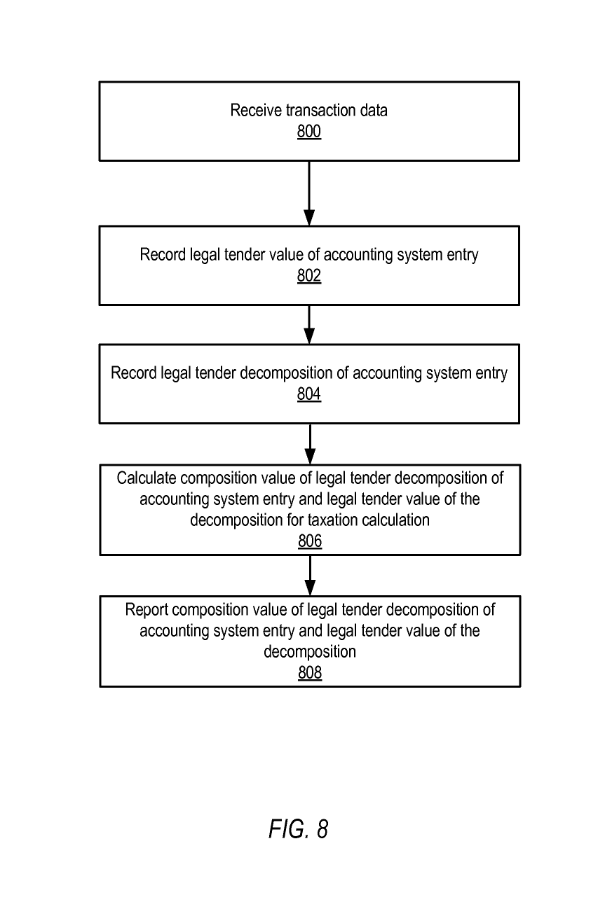

FIG. 8 is a high-level logical flowchart of operations that can be used for a recording of decomposition of accounting system entries with composition value computation, according to some embodiments. Transaction data is received (block 800). Legal tender value of an accounting system entry is recorded (block 802). Legal tender decomposition of the accounting system entry is recorded (block 804). A composition value of the legal tender decomposition of accounting system entry and legal tender value of the decomposition is calculated for taxation calculation (block 806). The composition value of legal tender decomposition of accounting system entry and legal tender value of the decomposition are reported (block 808).

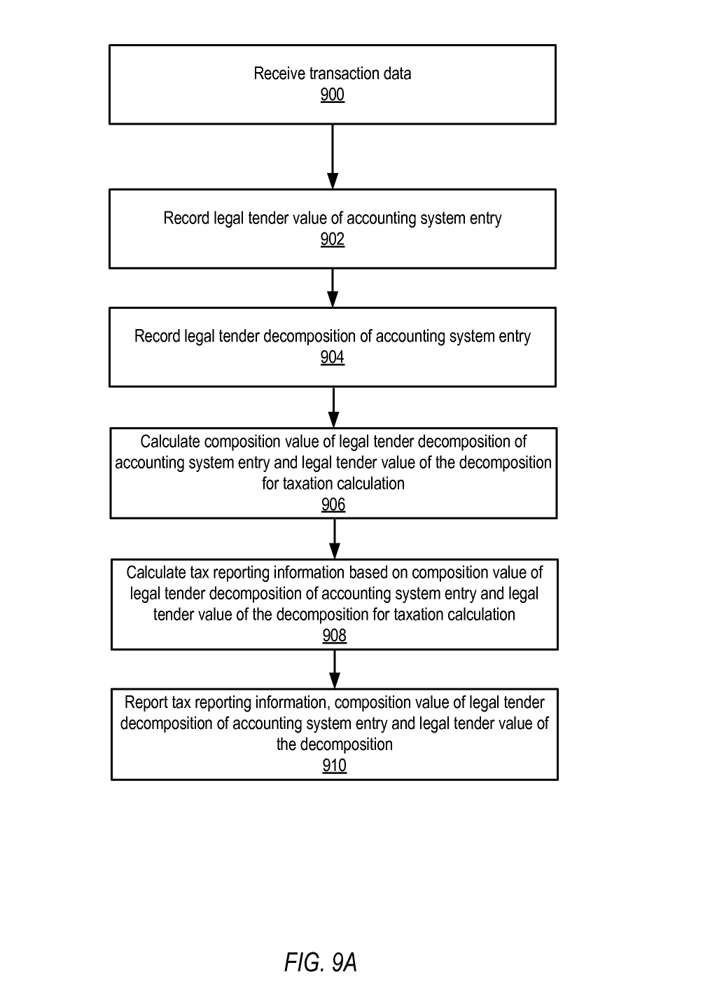

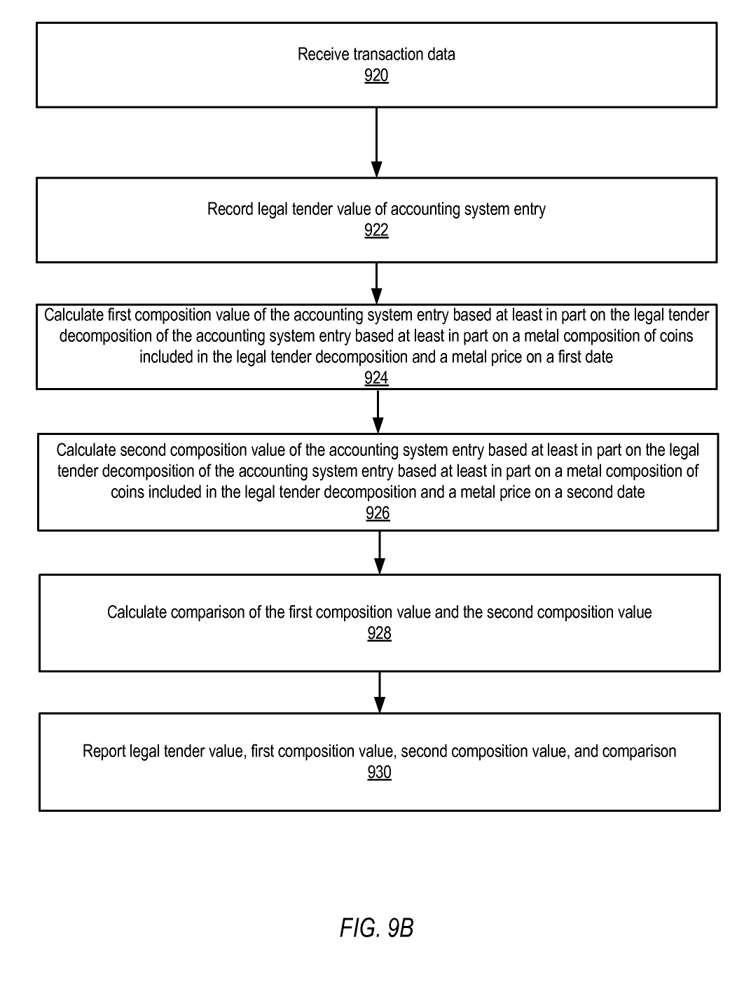

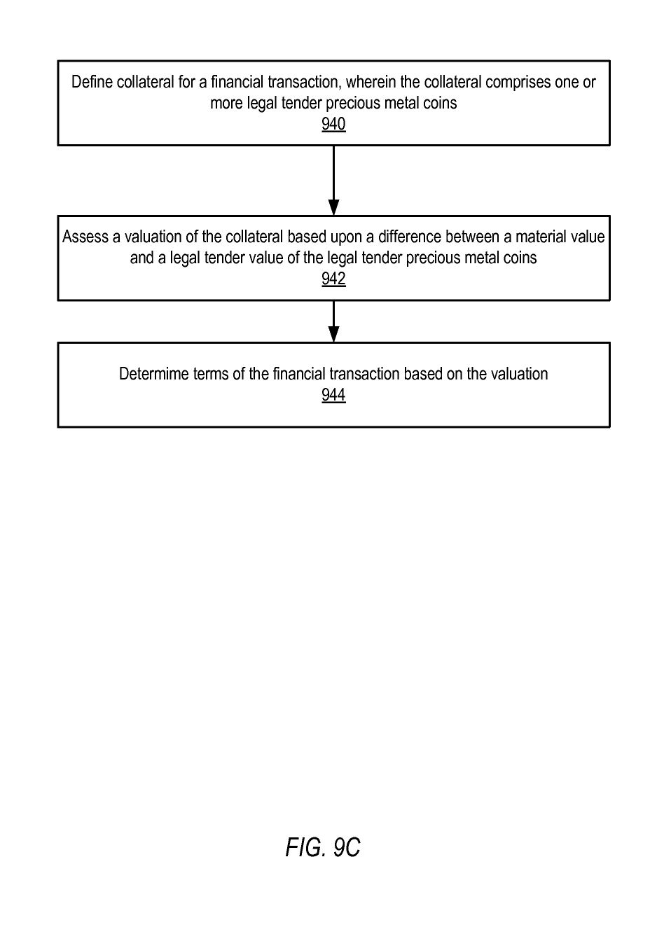

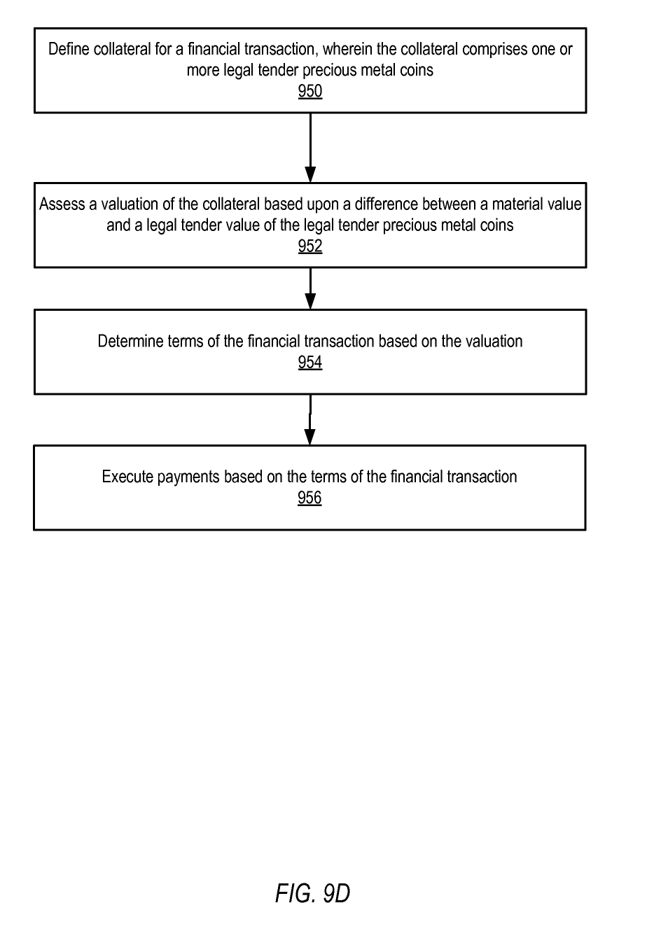

FIG. 9A is a high-level logical flowchart of operations that can be used for a recording of decomposition of accounting system entries with tax reporting, according to some embodiments. Transaction data is received (block 900). Legal tender value of an accounting system entry is recorded (block 902). A legal tender decomposition of the accounting entry is recorded (block 904). A composition value of legal tender decomposition of accounting system entry and legal tender value of the decomposition for taxation calculation is calculated (block 906). Tax reporting information is calculated based on composition value of legal tender decomposition of accounting system entry and legal tender value of the decomposition for taxation calculation (block 908). Tax reporting information, composition value of legal tender decomposition of accounting system entry and legal tender value of the decomposition are reported (block 910).

FIG. 9B is a high-level logical flowchart of operations that can be used for a recording of decomposition of accounting system entries with accounting computation for variable composition value, according to some embodiments. Transaction data is received (block 920). A legal tender value of an accounting system entry is recorded (block 922). A first composition value of the accounting system entry is calculated based at least in part on the legal tender decomposition of the accounting system entry and based at least in part on a metal composition of coins included in the legal tender decomposition and a metal price on a first date (block 924). A second composition value of the accounting system entry is calculated based at least in part on the legal tender decomposition of the accounting system entry and based at least in part on a metal composition of coins included in the legal tender decomposition and a metal price on a second date (block 926). A comparison of the first composition value and the second composition value is calculated (block 928). The legal tender value, first composition value, second composition value, and comparison are reported (block 930).

FIG. 9C is a high-level logical flowchart of operations that can be used for managing collateral-based financial transactions, according to some embodiments. Collateral for a financial transaction is defined. In some embodiments, the collateral includes one or more legal tender precious metal coins (block 940). A valuation of the collateral based upon a difference between a material value and a legal tender value of the legal tender precious metal coins is assessed (block 942). Terms of the financial transaction are determined based on the valuation (block 944).

FIG. 9D is a high-level logical flowchart of operations that can be used for managing collateral-based financial transactions, according to some embodiments. Collateral for a financial transaction is defined. In some embodiments, the collateral includes one or more legal tender precious metal coins (block 950). A valuation of the collateral based upon a difference between a material value and a legal tender value of the legal tender precious metal coins is assessed (block 952). Terms of the financial transaction are determined based on the valuation (block 954). Payments are executed based on the terms of the financial transaction (block 956).

In some embodiments, the determining the terms of the financial transaction further includes determining terms of a loan based upon the valuation. In some embodiments, the determining the terms of the financial transaction further includes determining terms of the financial transaction based on a dual treatment aggregate value of the collateral. In some embodiments, the determining the terms of the financial transaction further includes determining valuations of one or more futures contracts. In some embodiments, the determining the terms of the financial transaction further includes determining valuation of a present payment for an agreed future transfer of the collateral based on an agreed future value of the collateral. In some embodiments, the determining the terms of the financial transaction further includes determining terms of a line of credit based upon the valuation. In some embodiments, the determining the terms of the financial transaction further includes determining terms of a payment annuity based upon the valuation. In some embodiments, the determining the terms of the financial transaction further includes determining terms of an insurance contract based upon the valuation. In some embodiments, the determining the terms of the financial transaction further includes determining terms of a purchase transaction based upon the valuation.

### Example Transactions Supported by Some Embodiments

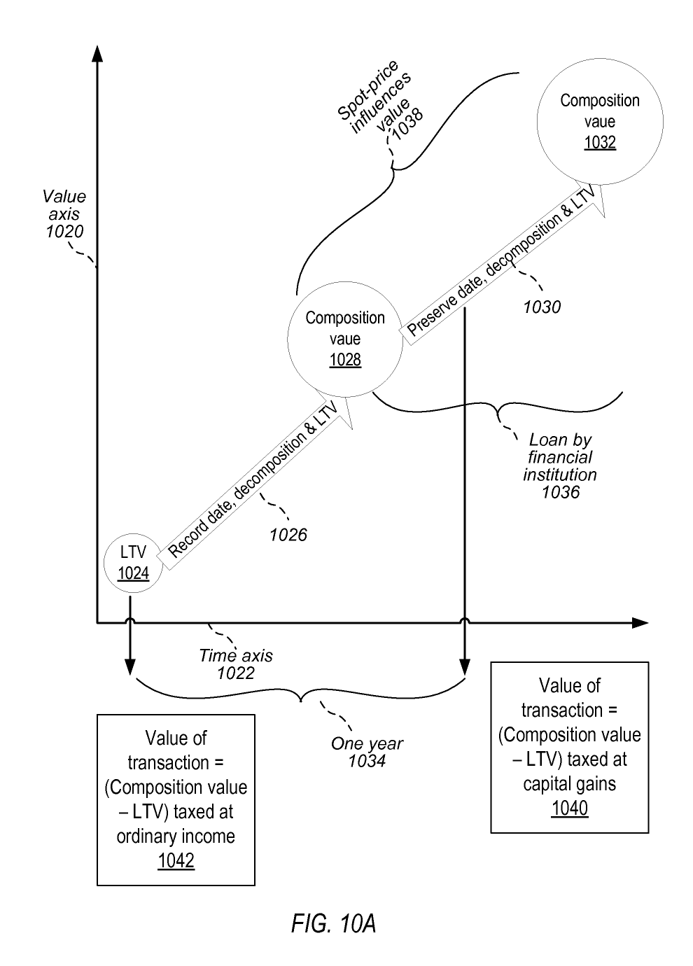

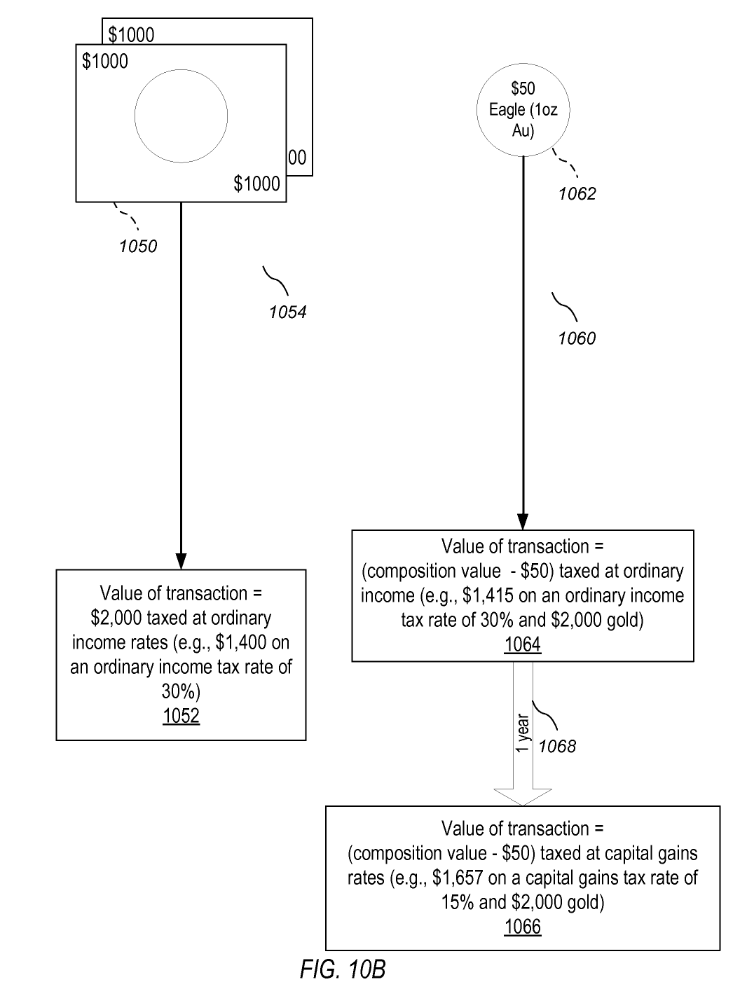

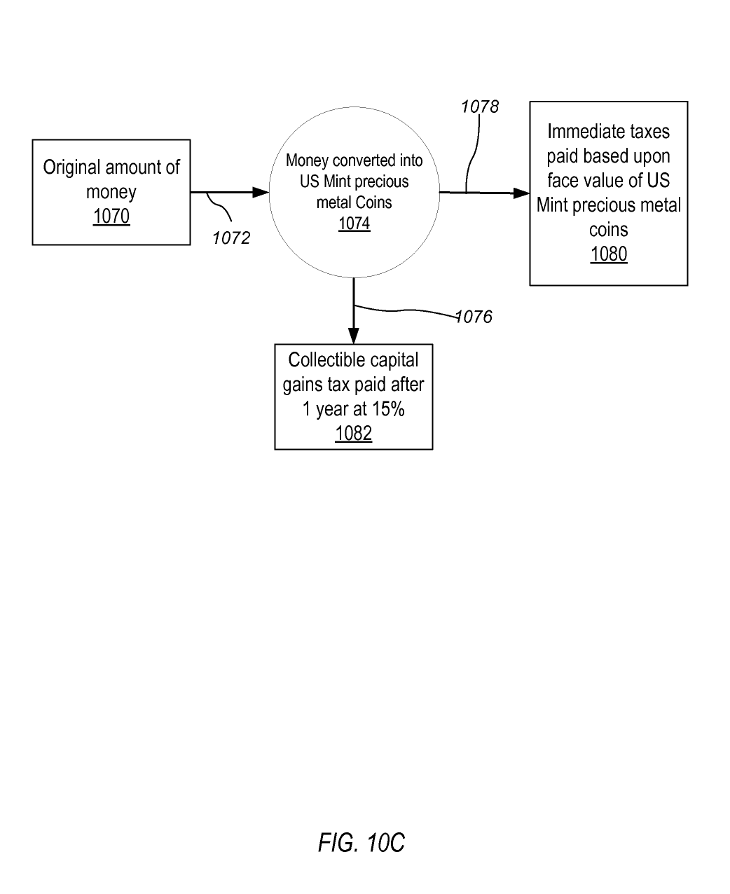

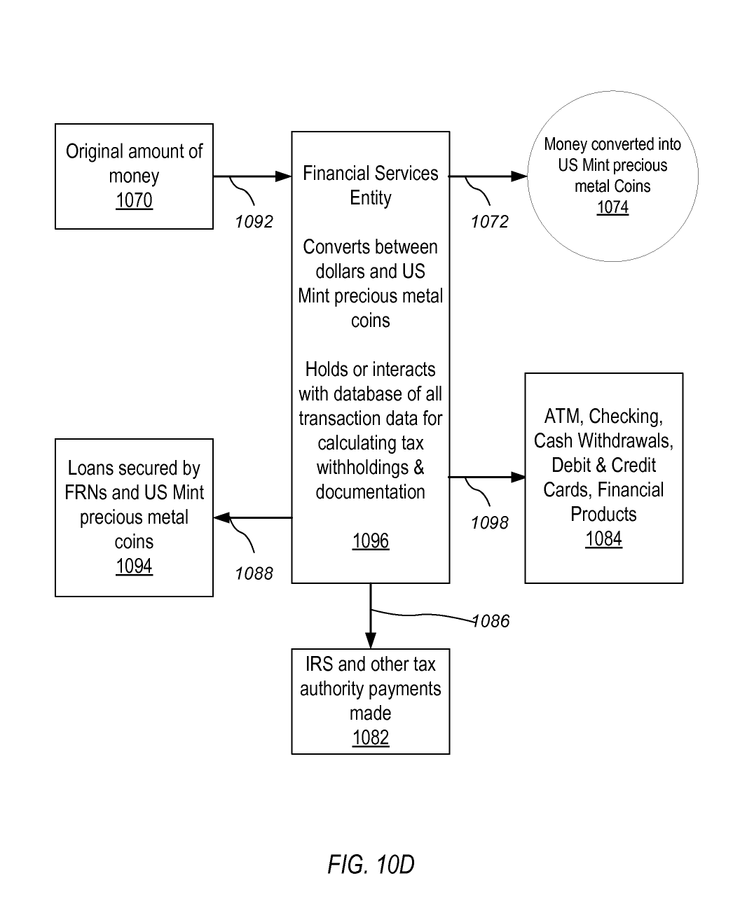

FIG. 10A is a time-value diagram of a transaction using recording of decomposition of accounting system entries with tax reporting, according to some embodiments. Measured along a time axis 1022 and a time axis 1020, the transaction has a transaction value (block 1042) during an initial one-year period 1034 based on a legal tender value (LTV) 1024 subtracted from a composition value 1028 and taxed at ordinary income tax rates. Operations are performed to record the legal tender value in a currency, the legal tender decomposition in the currency and a date (block 1026). Date, legal tender decomposition, and legal tender value are preserved (block 1030) and a second composition value 1032 can be calculated as time advances and changes in the spot prices of metals influence composition value 1038. Loans by a financial institution 1036 can be initiated based on composition value 1028 or second composition value 1032. Alternative embodiments support a wide range of futures contracts, derivatives, option contracts, payment stream annuities, and other financial transactions in place of loans. After the expiration of one year 1034, a transaction value equals the subtraction of the legal tender value 1024 from a most recent composition value 1032 taxed at a capital gains tax rate (block 1040). In some embodiments, transaction values at both block 1040 and block 1042 may be reduced by subtracting an ordinary income tax levied against the legal tender value.

FIG. 10B is a decomposition-value diagram of a transaction using recording of decomposition of accounting system entries with tax reporting, according to some embodiments. In a first transaction 1054, two $1000 Federal Reserve notes (FRNs) 1050 are received. The transaction has a value of $2000 taxed at ordinary income rates, which works out to $1400 on an ordinary income tax rate of 30% (block 952). Alternatively, in a second transaction 1060, a $50 gold eagle 962, with a composition of one ounce 0.999 gold, 1062 is received. The transaction has an immediate value of composition value less legal tender value taxed at ordinary income rates, which works out to $1415 on an ordinary income tax rate of 30% and $2000 gold (block 1064). One year later 1068, the tax treatment changes such that the transaction has a second value of composition value less legal tender value taxed at capital gains rates, which works out to $1657 on an capital gains tax rate of 15% and $2000 gold (block 1066).

FIG. 10C is a flow of finance diagram describing a transaction using recording of decomposition of accounting system entries with tax reporting, according to some embodiments. FIG. 10D is a flow of finance diagram describing institutional involvement in a transaction using recording of decomposition of accounting system entries with tax reporting, according to some embodiments. An amount of money 1070, which may be subject to a form of taxes including, but not limited to, gift taxes, estate taxes, inheritance taxes, income taxes, social security taxes, etc. is converted 1072 into US Mint precious metal coins 1074. Conversion 1072 is equivalent to exchanging some form of legal tender for an equivalent amount of legal tender in a different format. An example could include, for example, exchanging four quarters for a single one dollar bill.

In this case, the conversion 1072 is between a sum of money 1070 and the precious metal value of the US Mint precious metal coins 1074. For example, if the spot price of gold is $1,000 per ounce and a taxpayer has a lump sum amount 1070 of cash equaling $1,000, then the taxpayer could buy a single one-ounce $50 American Eagle gold coin 1074. In some embodiments, an accounting software system would record the date, amounts, price of precious metals and number of coins purchased during conversion 1072 in order to calculate the timing of the future sale of the gold coin in order to ensure that the collectible capital gains tax paid 1082 occurs after at least one year has passed 1076. The taxpayer may owe taxes immediately for the transaction 1080, but those taxes paid would be calculated based upon the legal tender value of the coins that were acquired 1074.

In some embodiments, financial services supported by the embodiment are provided by an entity 1096 including, but not limited to, a bank, savings and loan, a trust, a mutual fund, an employment agency, a school, a financial advisory firm, an investment bank, an asset management firm, a hedge fund, an insurance company, an annuity company, etc. A taxpayer's money 1072 can be deposited 1092 into the financial institution 1096. While the money resides in the financial institution 1096, it can be freely converted 1072 into US Mint precious metal coins 1074. The financial institution need not actually have a all of the coins in its possession 1074 for all of the taxpayer's funding 1070. Like most commercial banks that use fractional reserve banking, the financial institution 1096 can have a limited number of US Mint precious metal coins in it's possession, so long as its ratio of holdings to committed funds remains in line with the law.

Once a taxpayer's funds 1070 have been deposited 1092 into the financial institution 1096, the IRS' “one-year clock” for long-term capital gains starts. If the taxpayer wants or needs access to his funding 1088 before the one-year is up, the financial institution 1096 can make him a loan 1094 so that the US Mint precious metal coins are not sold early and taxed at a higher rate. If the taxpayer wants to access his money 1098 after the one year capital gains milestone has been passed, he may access his funds a number of ways 1084, including but not limited to, ATM cash machine withdrawals, debit and credit card transactions, checking accounts, cash withdrawals, stock purchases, bond purchases, etc.

The various transactions 1084 cause the financial institution 1096 to execute virtual US Mint precious metal coin sales 1074 that result in capital gains taxes being incurred 1086. The financial institution can pay those taxes on behalf of the taxpayer 1082 and provide the taxpayer with tax forms and other information through the mail, email, Internet and other forms of notification.

Financial service entity automates collection, recording, management and reporting of data so that taxes can be dynamically determined and paid, so the tax complexity of the transactions are invisible to the taxpayer at the time of the transactions. If the taxpayer tries to withdraw money too soon, the system can automate the creation and issuance of a loan secured by the cash 1070 and the US Mint precious metal coins 1074 already in the possession of the financial services entity 1096.

### Example User Interface

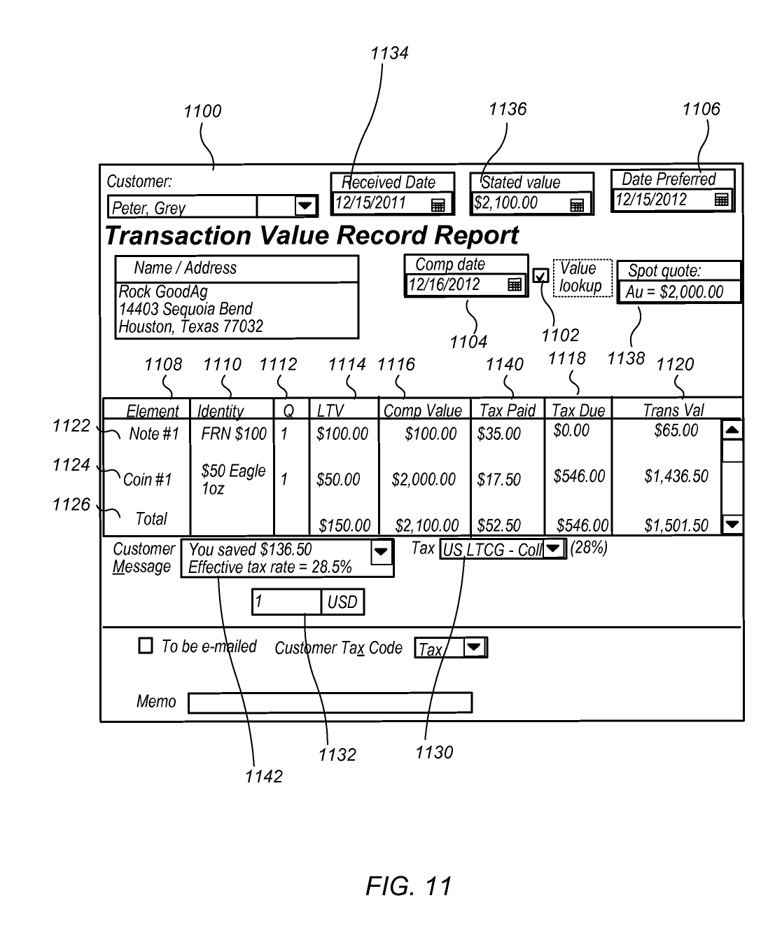

FIG. 11A depicts one embodiment of a graphical user interface for recording decomposition of accounting system entries. A transaction interface 1100 presents a report of a transaction in which a record of a first note 1122 and a record of a second note 1124 were recorded along with totals 1126 for the transaction, including a stated value 1136. In one embodiment represents, stated value 1136 represents an intended value of the transaction. For example, a transaction in which gold eagle with a composition value of $2000 and legal tender value of $50 was received with a $100 FRN may have a stated value of $2100. A value lookup control 1102 enables an accounting system to lookup composition values based on a spot price 1138 of one or more precious metals for a composition date 1104, and tax treatments are calculated between a date received 1134 and composition date 1104, with a notation of a date on which preferred tax treatment will become or did become available 1106.

A preferred tax treatment 1130 is indicated, as is a currency in which record of a first note 1122 record of a first coin 1124 were recorded. In the embodiment shown in FIG. 11, record of a first note 1122 record of a first coin 1124 are elements of a legal tender decomposition of an accounting entry and total 1126 of legal tender value 1114 is a legal tender value of the accounting entry. Each of record of a first note 1122 record of a first coin 1124 includes an element identifier 1108, an identity 1110 of a coin or bank note, a quantity 1112, a legal tender value 1114 a composition value 1116, a tax paid at ordinary income rates on the received date 1140, a tax due 1118 to be paid to close a tax transaction on the composition date 1104, and a transaction value 1120. In some embodiments, transaction value 1120 is a dual-treatment aggregate value. In some embodiments, transaction value 1120 is used to support financial transactions such as loans, option contracts, futures contracts, or payment contracts secured by the assets represented by the legal tender decomposition.

An indication of tax savings 1142 is provided. A unit of currency 1132 in which a legal tender value and a legal tender decomposition are defined is displayed. Embodiments support a wide range of futures contracts, derivatives, option contracts, payment stream annuities, secured transactions, loans, and other financial transactions, products, and services. In some embodiments, spot prices are replaced with futures contracts or other instruments for guaranteeing set agreed prices and resulting predictability in material values and composition values. Such embodiments support, for example, use of a futures contract to structure an inheritance transaction such that heirs take the money at a present time based on a transaction value 1120 with tax savings 1142 based on a long-term capital gains tax treatment 1130 through the intervention of a financial institution holding in inventory notes and coins representing a legal tender decomposition (e.g., a first note noted in record of first note 1122 and first coin noted in record of first coin 1124) for the appropriate period of time (e.g., 1 year) and guaranteeing a sale price, rather than the spot price at an agreed level via futures contracts.

Additionally, some embodiments support transactions with cash advances based on a loan secured by intervention of a financial institution holding in inventory notes and coins representing a legal tender decomposition (e.g., a first note noted in record of first note 1122 and first coin noted in record of first coin 1124) for the appropriate period of time (e.g., 1 year) with no guaranteed sales price. Some embodiments support cash advances based on a loan secured by intervention of a financial institution holding in inventory notes and coins representing a legal tender decomposition (e.g., a first note noted in record of first note 1122 and first coin noted in record of first coin 1124) with variable interest rates based at least in part on floating spot prices.

### Example Operations for Use in Some Embodiments to Support Financial Transactions

FIG. 12A is a high-level logical flowchart of operations that can be used for supporting financial services transactions based at least in part on decomposition of accounting system entries, according to some embodiments. A legal tender value of an accounting system entry is recorded (block 1202). A legal tender decomposition of an accounting system entry is recorded (block 1204). A proposed transaction report for a financial services transaction is prepared for a proposed transaction described in the proposed transaction report that depends at least in part on the legal tender value and the legal tender decomposition (block 1206).

FIG. 12B is a high-level logical flowchart of operations that can be used for preparing proposed transaction reports in support of financial services transactions based at least in part on decomposition of accounting system entries, according to some embodiments. A composition value based in part on the legal tender decomposition is calculated (block 1212). A dual-treatment aggregate value based in part on the composition value is calculated (block 1214). Terms of the financial services transaction for use in the proposed transaction report are designated (block 1216).

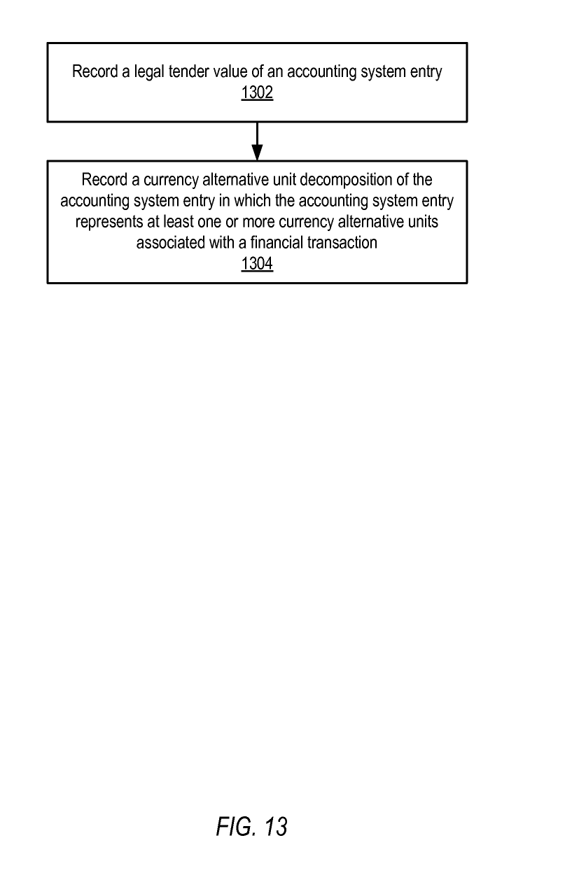

FIG. 13 is a high-level logical flowchart of operations that can be used for operations on accounting system entries that may be recorded for currency alternative units, according to some embodiments. A legal tender value of an accounting system entry is recorded (block 1302). A currency alternative unit decomposition of the accounting system entry in which the accounting system entry represents at least one or more currency alternative units associated with a financial transaction is recorded (block 1304).

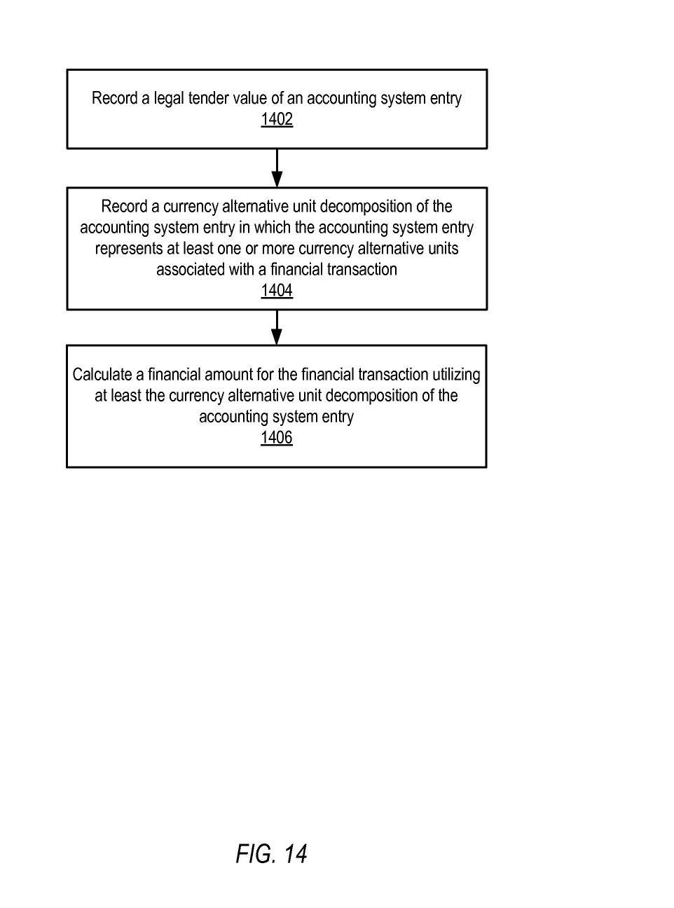

FIG. 14 is a high-level logical flowchart of operations that can be used for operations on accounting system entries that may be recorded for currency alternative units, according to some embodiments. A legal tender value of an accounting system entry is recorded (block 1402). A currency alternative unit decomposition of the accounting system entry in which the accounting system entry represents at least one or more currency alternative units associated with a financial transaction is recorded (block 1404). A financial amount for the financial transaction is calculated utilizing at least the currency alternative unit decomposition of the accounting system entry (block 1406).

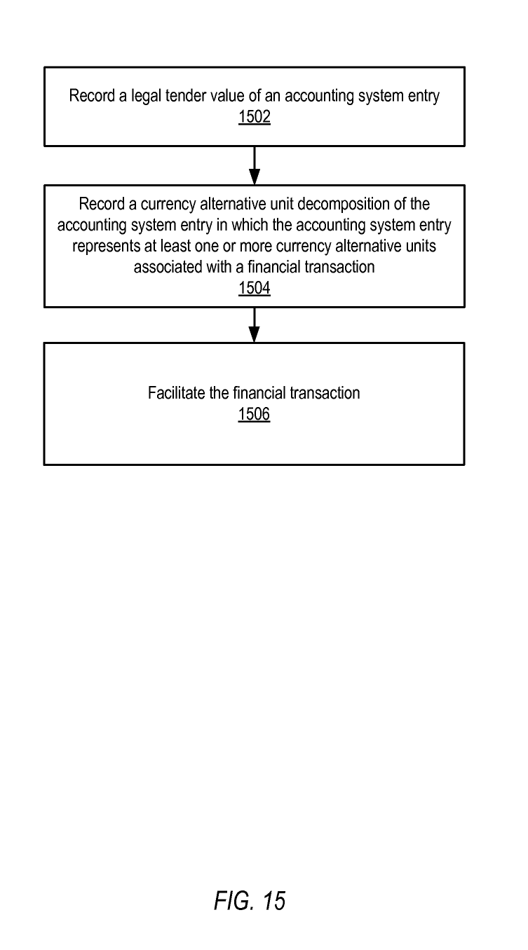

FIG. 15 is a high-level logical flowchart of operations that can be used for operations on accounting system entries that may be recorded for currency alternative units, according to some embodiments. A legal tender value of an accounting system entry is recorded (block 1502). A currency alternative unit decomposition of the accounting system entry in which the accounting system entry represents at least one or more currency alternative units associated with a financial transaction is recorded (block 1504). The financial transaction is facilitated (block 1506).

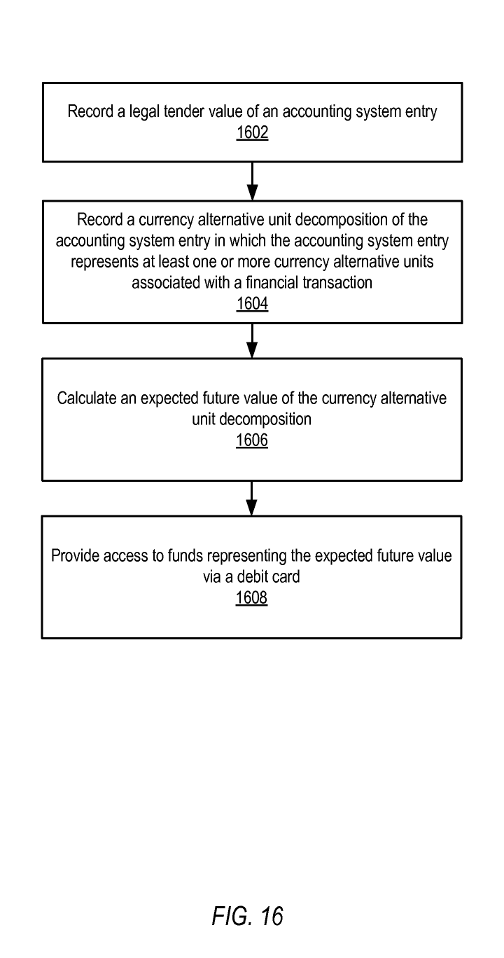

FIG. 16 is a high-level logical flowchart of operations that can be used for operations on accounting system entries that may be recorded for currency alternative units, according to some embodiments. A legal tender value of an accounting system entry is recorded (block 1602). A currency alternative unit decomposition of the accounting system entry in which the accounting system entry represents at least one or more currency alternative units associated with a financial transaction is recorded (block 1604). An expected future value of the currency alternative unit decomposition is calculated (block 1606). Access to funds representing the expected future value is provided via a debit card (block 1608).

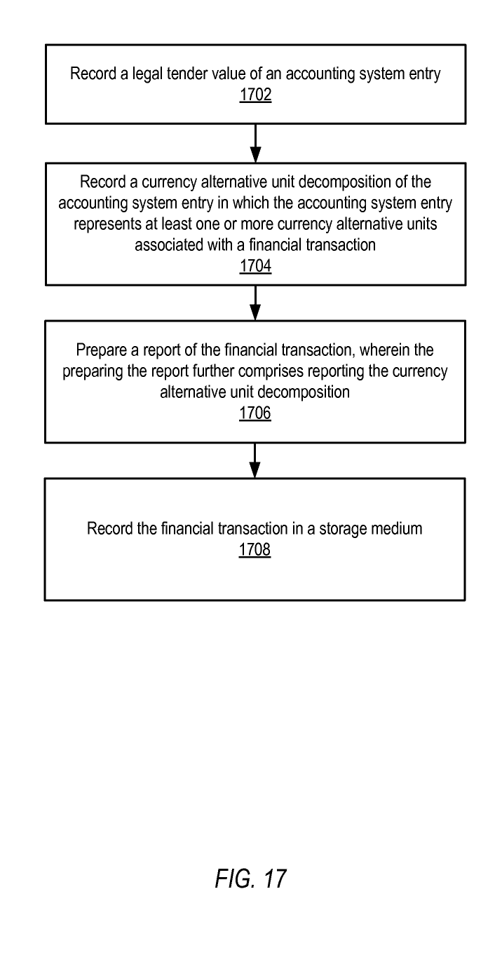

FIG. 17 is a high-level logical flowchart of operations that can be used for operations on accounting system entries that may be recorded for currency alternative units, according to some embodiments. A legal tender value of an accounting system entry is recorded (block 1702). A currency alternative unit decomposition of the accounting system entry in which the accounting system entry represents at least one or more currency alternative units associated with a financial transaction is recorded (block 1704). A report of the financial transaction, wherein the preparing the report further includes reporting the currency alternative unit decomposition (block 1706). The financial transaction in a storage medium (block 1708).

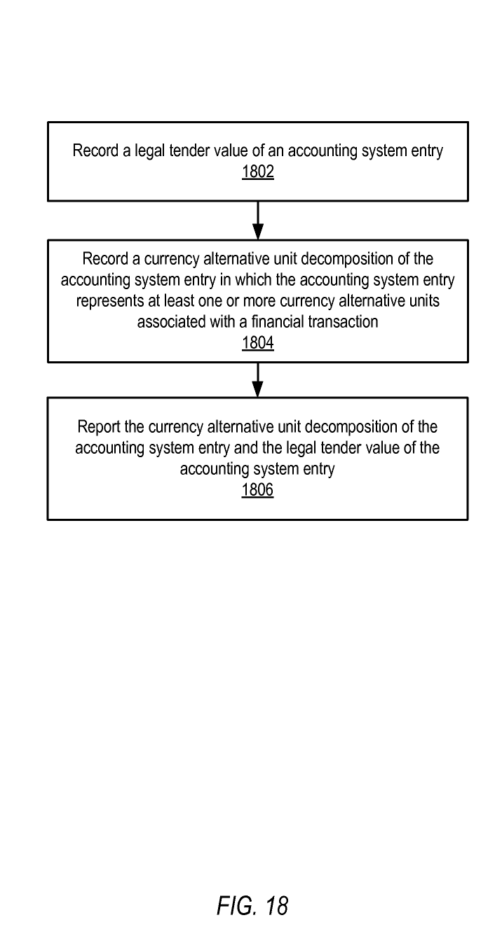

FIG. 18 is a high-level logical flowchart of operations that can be used for operations on accounting system entries that may be recorded for currency alternative units, according to some embodiments. A legal tender value of an accounting system entry is recorded (block 1802). A currency alternative unit decomposition of the accounting system entry in which the accounting system entry represents at least one or more currency alternative units associated with a financial transaction is recorded (block 1804). The currency alternative unit decomposition of the accounting system entry and the legal tender value of the accounting system entry are reported (block 1806).

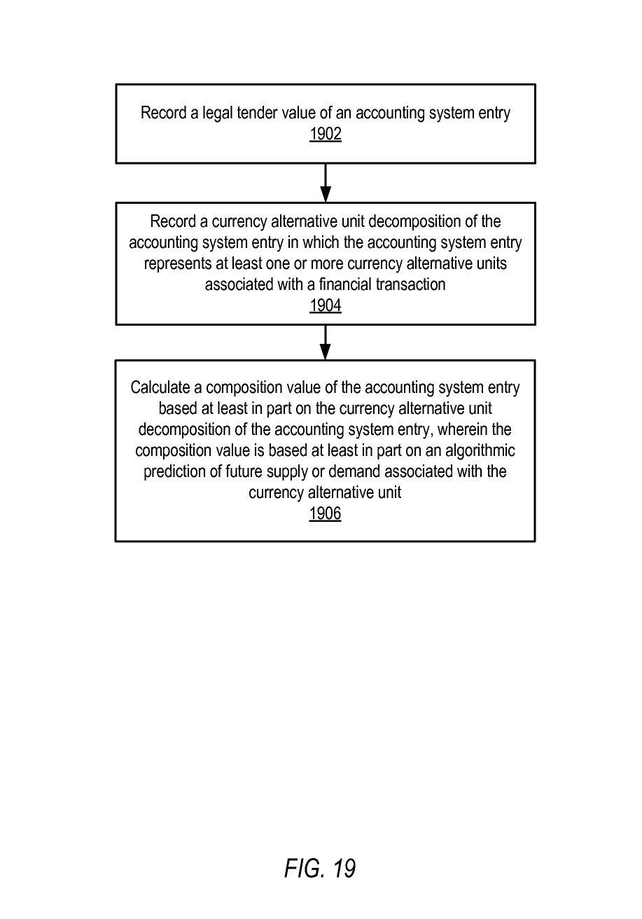

FIG. 19 is a high-level logical flowchart of operations that can be used for operations on accounting system entries that may be recorded for currency alternative units, according to some embodiments. A legal tender value of an accounting system entry is recorded (block 1902). A currency alternative unit decomposition of the accounting system entry in which the accounting system entry represents at least one or more currency alternative units associated with a financial transaction is recorded (block 1904). A composition value of the accounting system entry based at least in part on the currency alternative unit decomposition of the accounting system entry, wherein the composition value is based at least in part on an algorithmic prediction of future supply or demand associated with the currency alternative unit, is calculated (block 1906).

FIG. 20A is a high-level logical flowchart of operations that can be used for operations on accounting system entries that may be recorded for currency alternative units, according to some embodiments. A legal tender value of an accounting system entry is recorded (block 2002). A currency alternative unit decomposition of the accounting system entry in which the accounting system entry represents at least one or more currency alternative units associated with a financial transaction is recorded (block 2004). An expected future value of the currency alternative unit decomposition is calculated (block 2006). Access to funds representing the expected future value is provided via a credit card (block 2008).

FIG. 20B is a high-level logical flowchart of operations that can be used for operations on accounting system entries that may be recorded for currency alternative units, according to some embodiments. A legal tender value of an accounting system entry is recorded (block 2012). A currency alternative unit decomposition of the accounting system entry in which the accounting system entry represents at least one or more currency alternative units associated with a financial transaction is recorded (block 2014). A future value of the currency alternative unit decomposition of the accounting system entry is estimated (block 2016). A futures contract representing the future value is utilized to establish a non-volatile value of the currency alternative unit (block 2018). Access to funds is provided based on the non-volatile value (block 2020).

FIG. 20C is a flow of finance diagram describing a transaction using recording of decomposition of accounting system entries with tax reporting, according to some embodiments. An amount of money 2070, which may be subject to a form of taxes including, but not limited to, gift taxes, estate taxes, inheritance taxes, income taxes, social security taxes, etc. is converted 1072 into currency alternative units 1074. Conversion 2072 is equivalent to exchanging some form of legal tender for an equivalent amount of virtual currency. An example could include, for example, exchanging $200 for a Bitcoin.

In this case, the conversion 2072 is between a sum of money 2070 and the virtual currency value of the currency alternative units 1074. For example, if the spot price of Bitcoin is $200 per coin and a taxpayer has a lump sum amount 2070 of cash equaling $200, then the taxpayer could buy a single Boitcoin 2074. In some embodiments, an accounting software system would record the date, amounts, price of precious metals and number of coins purchased during conversion 2072 in order to calculate the timing of the future sale of the gold coin in order to ensure that the collectible capital gains tax paid 2082 occurs after at least one year has passed. The taxpayer may owe taxes immediately for the transaction.

In some embodiments, financial services supported by the embodiment are provided by an entity 2096 including, but not limited to, a bank, savings and loan, a trust, a mutual fund, an employment agency, a school, a financial advisory firm, an investment bank, an asset management firm, a hedge fund, an insurance company, an annuity company, etc. A taxpayer's money 2072 can be deposited 2092 into the financial institution 2096. While the money resides in the financial institution 2096, it can be freely converted 2072 into currency alternative units 2074. The financial institution need not actually have all of the currency alternative units 2074 for all of the taxpayer's funding 2070. Like most commercial banks that use fractional reserve banking, the financial institution 2096 can have a limited number of currency alternative units in it's possession, so long as its ratio of holdings to committed funds remains in line with the law.

Once a taxpayer's funds 2070 have been deposited 2092 into the financial institution 2096, the IRS' “one-year clock” for long-term capital gains starts. If the taxpayer wants or needs access to his funding 2088 before the one-year is up, the financial institution 2096 can make him a loan 2094, for example using a futures contract, so that the Bitcoins coins are not sold early and taxed at a higher rate. If the taxpayer wants to access his money 2098 after the one year capital gains milestone has been passed, he may access his funds a number of ways 2084, including but not limited to, ATM cash machine withdrawals, debit and credit card transactions, checking accounts, cash withdrawals, stock purchases, bond purchases, etc.

The various transactions 2084 cause the financial institution 2096 to execute virtual currency alternative unit sales 2074 that result in capital gains taxes being incurred 2086. The financial institution can pay those taxes on behalf of the taxpayer 2082 and provide the taxpayer with tax forms and other information through the mail, email, Internet and other forms of notification.

Financial service entity automates collection, recording, management and reporting of data so that taxes can be dynamically determined and paid, so the tax complexity of the transactions are invisible to the taxpayer at the time of the transactions. If the taxpayer tries to withdraw money too soon, the system can automate the creation and issuance of a loan secured by the cash 2070 and the currency alternative units 2074 already in the possession of the financial services entity 2096.

### Example System

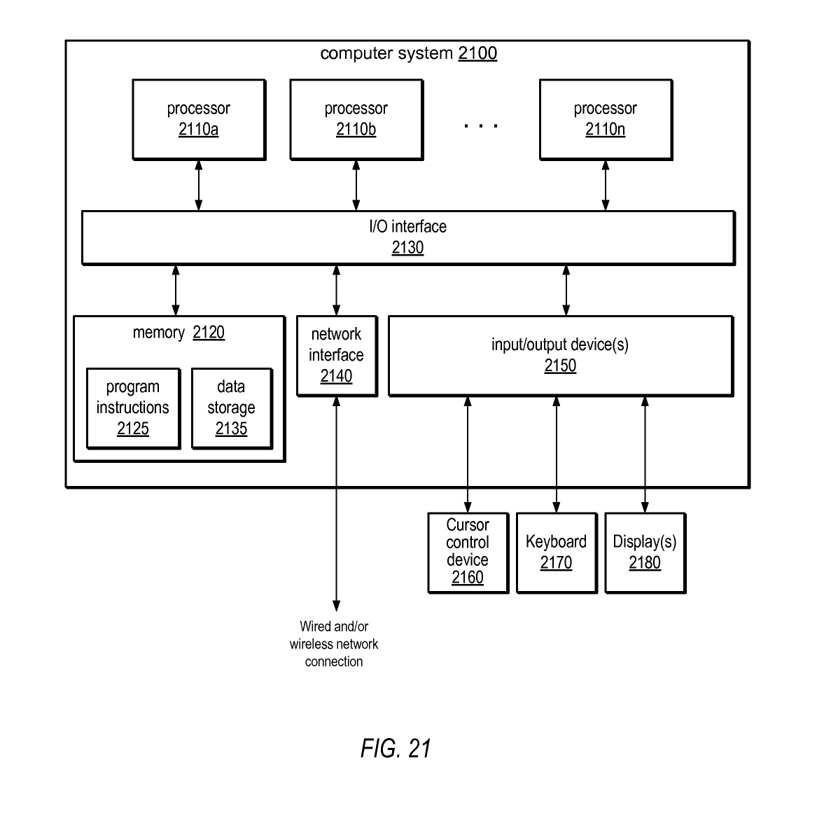

Embodiments of a system and method for legal tender decompositions of accounting entries as described herein may be executed on one or more computer systems, which may interact with various other devices. One such computer system is illustrated by FIG. 21. In different embodiments, computer system 2100 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 2100 includes one or more processors 2110 coupled to a system memory 2120 via an input/output (I/O) interface 2130. Computer system 2100 further includes a network interface 2140 coupled to I/O interface 2130, and one or more input/output devices 2150, such as cursor control device 2160, keyboard 2170, and display(s) 2180. In some embodiments, it is contemplated that embodiments may be implemented using a single instance of computer system 2100, while in other embodiments multiple such systems, or multiple nodes making up computer system 2100, may be configured to host different portions or instances of embodiments. For example, in one embodiment some elements may be implemented via one or more nodes of computer system 2100 that are distinct from those nodes implementing other elements.

In various embodiments, computer system 2100 may be a uniprocessor system including one processor 2110, or a multiprocessor system including several processors 2110 (e.g., two, four, eight, or another suitable number). Processors 2110 may be any suitable processor capable of executing instructions. For example, in various embodiments, processors 2110 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

System memory 2120 may be configured to store program instructions and/or data accessible by processor 2110. In various embodiments, system memory 2120 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for embodiments of a transaction management module are shown stored within system memory 2120 as program instructions 2125 and data storage 2135, respectively. In other embodiments, program instructions and/or data may be received, sent or stored upon different types of computer-accessible media or on similar media separate from system memory 2120 or computer system 2100. Generally speaking, a computer-accessible medium may include storage media or memory media such as magnetic or optical media, e.g., disk or CD/DVD-ROM coupled to computer system 2100 via I/O interface 2130. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 2140.

In one embodiment, I/O interface 2130 may be configured to coordinate I/O traffic between processor 2110, system memory 2120, and any peripheral devices in the device, including network interface 2140 or other peripheral interfaces, such as input/output devices 2150. In some embodiments, I/O interface 2130 may perform any necessary protocol, timing or other data transformations to convert data signals from one component (e.g., system memory 2120) into a format suitable for use by another component (e.g., processor 2110). In some embodiments, I/O interface 2130 may include support for devices attached through various types of peripheral buses, such as a variant of the Peripheral Component Interconnect (PCI) bus standard or the Universal Serial Bus (USB) standard, for example. In some embodiments, the function of I/O interface 2130 may be split into two or more separate components, such as a north bridge and a south bridge, for example. In addition, in some embodiments some or all of the functionality of I/O interface 2130, such as an interface to system memory 2120, may be incorporated directly into processor 2110.

Network interface 2140 may be configured to allow data to be exchanged between computer system 2100 and other devices attached to a network, such as other computer systems, or between nodes of computer system 2100. In various embodiments, network interface 2140 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 2150 may, in some embodiments, include one or more display terminals, keyboards, keypads, touchpads, scanning devices, voice or optical recognition devices, or any other devices suitable for entering or retrieving data by one or more computer system 2100. Multiple input/output devices 2150 may be present in computer system 2100 or may be distributed on various nodes of computer system 2100. In some embodiments, similar input/output devices may be separate from computer system 2100 and may interact with one or more nodes of computer system 2100 through a wired or wireless connection, such as over network interface 2140.

As shown in FIG. 21, memory 2120 may include program instructions 2125, configured to implement embodiments of a decomposition recording module as described herein, and data storage 2135, comprising various data accessible by program instructions 2125. In one embodiment, program instructions 2125 may include software elements of embodiments of a transaction management module as illustrated in the above Figures. Data storage 2135 may include data that may be used in embodiments. In other embodiments, other or different software elements and data may be included.

Those skilled in the art will appreciate that computer system 2100 is merely illustrative and is not intended to limit the scope of a transaction management module as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 2100 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 2100 may be transmitted to computer system 2100 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A method, comprising:
using one or more processors to perform
recording a legal tender value of an accounting system entry; and
recording a currency alternative unit decomposition of the accounting system entry, wherein
the accounting system entry represents at least one or more currency alternative units associated with a financial transaction.

2. The method of claim 1, further comprising:
calculating a financial amount for the financial transaction utilizing at least the currency alternative unit decomposition of the accounting system entry.

3. The method of claim 1, further comprising:
facilitating the financial transaction.

4. The method of claim 1, wherein
the calculating a financial amount for the financial transaction utilizing at least the currency alternative unit decomposition of the accounting system entry further comprises calculating a financial amount for the financial transaction utilizing at least the currency alternative unit decomposition representing an amount of virtual currency units.

5. The method of claim 1, wherein the facilitating the financial transaction further comprises:
calculating an expected future value of the currency alternative unit decomposition based upon a non-volatile value.

6. The method of claim 1, wherein
the calculating a financial amount for the financial transaction utilizing at least the currency alternative unit decomposition of the accounting system entry further comprises calculating a financial amount for the financial transaction utilizing at least the currency alternative unit decomposition representing an amount of legal tender bullion coins.

7. The method of claim 1, further comprising:
preparing a report of the financial transaction, wherein the preparing the report further comprises reporting the currency alternative unit decomposition; and
recording the financial transaction in a storage medium.

8. The method of claim 1, further comprising,
reporting the currency alternative unit decomposition of the accounting system entry and the legal tender value of the accounting system entry.

9. The method of claim 1, further comprising
calculating a composition value of the accounting system entry based at least in part on the currency alternative unit decomposition of the accounting system entry, wherein the composition value is based at least in part on an algorithmic prediction of future supply or demand associated with the currency alternative unit.

10. The method of claim 1, further comprising providing access to funds representing an expected future value via a debit card.

11. The method of claim 1, wherein the facilitating the financial transaction further comprises:
calculating an expected future value of the currency alternative unit decomposition.

12. A system, comprising:
at least one processor; and
a memory comprising program instructions, wherein the program instructions are executable by the at least one processor to:
record a legal tender value of an accounting system entry; and
record a currency alternative unit decomposition of the accounting system entry, wherein
the accounting system entry represents at least one or more currency alternative units associated with a financial transaction.

13. The system of claim 12, further comprising:
program instructions executable by the at least one processor to calculate a financial amount for the financial transaction utilizing at least the currency alternative unit decomposition of the accounting system entry.

14. The system of claim 12, further comprising:
program instructions executable by the at least one processor to facilitate the financial transaction.

15. The system of claim 12, wherein
the program instructions executable by the at least one processor to calculate a financial amount for the financial transaction utilizing at least the currency alternative unit decomposition of the accounting system entry further comprise program instructions executable by the at least one processor to calculate a financial amount for the financial transaction utilizing at least the currency alternative unit decomposition representing an amount of virtual currency units.

16. A non-transitory computer-readable storage medium storing program instructions,
wherein the program instructions are computer-executable to implement:
recording a legal tender value of an accounting system entry; and
recording a currency alternative unit decomposition of the accounting system entry, wherein the accounting system entry represents at least one or more currency alternative units associated with a financial transaction.

17. The non-transitory computer-readable storage medium of claim 16, further comprising:
program instructions computer-executable to implement calculating a financial amount for the financial transaction utilizing at least the currency alternative unit decomposition of the accounting system entry.

18. The non-transitory computer-readable storage medium of claim 17, further comprising:
program instructions computer-executable to implement facilitating the financial transaction.

19. The non-transitory computer-readable storage medium of claim 17, wherein the program instructions computer-executable to implement calculating a financial amount for the financial transaction utilizing at least the currency alternative unit decomposition of the accounting system entry further comprise program instructions computer-executable to implement calculating a financial amount for the financial transaction utilizing at least the currency alternative unit decomposition representing an amount of virtual currency units.

20. The non-transitory computer-readable storage medium of claim 17, wherein the program instructions computer-executable to implement facilitating the financial transaction further comprise:
program instructions computer-executable to implement calculating an expected future value of the currency alternative unit decomposition, and
program instructions computer-executable to implement providing access to funds representing the expected future value via a debit card.
